(19) United States
(12) Patent Application Publication
(10) Pub. No.: US 2026/0102315 A1
(43) Pub. Date: Apr. 16, 2026

(54) METHOD AND SYSTEM FOR PROVIDING CONNECTIVITY FOR A BATHING UNIT SYSTEM

(71) Applicant: GECKO ALLIANCE GROUP INC., Québec (CA)

(72) Inventors: Guillaume TREMBLAY, Québec (CA); Guillaume SÉNÉCHAL, Lévis (CA)

(21) Appl. No.: 18/917,470

(22) Filed: Oct. 16, 2024

(51) Int. Cl. A61H 33/00; E04H 4/00; E04H 4/12; H04B 17/309; H04W 4/80

(52) U.S. Cl. CPC A61H 33/005; A61H 33/0095; A61H 33/6005; E04H 4/129; H04B 17/309; H04W 4/80; A61H 2201/5015; E04H 4/0037

(57) ABSTRACT

Described herein are methods and systems for providing connectivity for a bathing unit system. The system can include a spa body with a water receptacle for holding water, bathing unit components including at least one heater and a circulation pump, a control system configured to generate control signals for controlling operational settings of one or more of the plurality of bathing unit components including the at least one heater and the circulation pump, and at least two communication interfaces positioned in the spa body. Each of the at least two communication interfaces being for exchanging of information between the control system and an external communication network. The at least two communication interfaces including a first communication interface and a second communication interface, wherein the first communication interface is spaced apart from the second communication interface on the spa body.

### TECHNICAL FIELD

The disclosure relates generally to the field of bathing unit systems and, more specifically, to providing network connectivity in bathing unit systems, such as therapeutic pools, fitness pools, spas, hot tubs, baths and the like.

### BACKGROUND

For some time, consumers have enjoyed the recreational and hydro-therapeutic benefits of spas, pools, hot tubs, whirlpools, and jetted baths, generally referred to “bathing unit systems”. Bathing unit systems can serve as a retreat for relaxation or socialization. Such bathing unit systems also include control systems for activating and managing the various parameters of the bathing unit systems. Typically, such a control system includes a control system to which are connected the various bathing unit components. The control system receives input signals from various input devices, such as, for example, a plurality of sensors that monitor the various components of the bathing unit system and from a control panel that allows a user to control various operational settings of these components. In response to the input signals, the control system activates, or deactivates, the various bathing unit components by supplying power, or ceasing to supply power, to the components, or otherwise modulates them.

Modern bathing unit systems often have many built-in functionalities to increase a user's enjoyment or satisfaction of using a bathing unit system. For example, a bathing unit system may be equipped with various entertainment capabilities including audio or visual components or may be equipped with the ability to connect to remote monitoring and control systems. To enable such functions, the control system typically communicates with components that provide network connectivity. A wide variety of wired and wireless connections to the bathing unit equipment are possible, such as a smart telephone that can directly connect with the bathing unit equipment via a Bluetooth or a household-based Wi-Fi router that can generate a Wi-Fi signal used by the bathing unit equipment to connect to a network.

However, bathing unit systems often experience issues with network connectivity which are specific to bathing unit systems. For example, as bathing unit systems are often located outside, such as in a backyard of a home, various obstacles such as outer walls, outer windows and installation may prevent a strong signal from being received by a communication device (e.g., network transceiver) of a bathing unit system from a home Wi-Fi router. Additionally, presence of water held by a receptacle of the bathing unit system may also attenuate signals received by the communication device of the bathing unit system. Further, the presence of snow or precipitation around the bathing unit system, the presence of outside shrubbery and greenery, an orientation of the communication device and various other factors may affect the strength of signals received by the communication device. A technician may try, using trial and error, to adjust the communication device; however, this does not always work and is dependent on the skill of the technician. As a result, connectivity issues a persistent problem for bathing unit systems.

Some approaches have been proposed to attempt to alleviate some of the above deficiencies. For example, one solution is to use a radio frequency (RF) antenna that employs an RF signal that may be less attenuated by water than Wi-Fi signals. However, RF bandwidth is limited, and there may be a point at which a bathing unit system using such a solution will be unable to provide all of the functionalities for which a modern bathing unit system is equipped. Another solution may be to use a cellular signal, such as 3G, 4G, LTE or 5G. However, the added costs associated with implementing cellular connectivity may be undesirable.

Against the background described above, there remains a need in the industry to provide a network connectivity solution that alleviates at least part the deficiencies associated with existing bathing unit systems.

### SUMMARY

The current disclosure relates generally to a bathing unit system having a connectivity unit which can be configured in different ways to overcome problems due to different signal strength at different locations on the bathing unit system. For example, the connectivity unit may include more than one (e.g., at least two) communication interface positioned at different locations on the bathing unit system. The connectivity unit may also be configured so that different communication devices (different types, or different ranges) may be removably received in a communication interface. The connectivity unit may also be configured such that a communication interface is movable to different locations on the bathing unit system. The inclusion of more than one communication interface, the ability to use change communication devices and/or the use of a communication interface which may be movable can all increase the likelihood that, when the bathing unit system is installed, there is at least one communication interface positioned (or movable) closer to a source of network signals and/or at least one communication device which is capable of receiving a sufficiently strong signal from the source of the network signals.

In some aspects, the embodiments described herein relate to a bathing unit system including: a spa body including a water receptacle for holding water; a plurality of bathing unit components including at least one heater and a circulation pump, the at least one heater and the circulation pump being installed in a circulation system configured for circulating water to and from the water receptacle; a control system configured to generate control signals for controlling operational settings of one or more of the plurality of bathing unit components including the at least one heater and the circulation pump; and at least two communication interfaces positioned in the spa body, each of the at least two communication interfaces being for exchanging of information between the control system and an external communication network, the at least two communication interfaces including a first communication interface and a second communication interface, wherein the first communication interface is spaced apart from the second communication interface on the spa body.

The bathing unit system may further include a processor configured for: (a) processing signals originating from the first communication interface and the second communication interface to identify a preferred communication interface between the first communication interface and the second communication interface. The preferred communication interface may be associated with signals having quality measurements: (i) exceeding a threshold quality level; and/or (ii) exceeding quality measurements of another communication interface amongst the first communication interface and the second communication interface. The processor may further be configured for (b) using the preferred communication interface to establish a communication link between the control system and the external communication network for the exchanging of the information.

The quality measurements may include at least one of a signal-to-noise ratio, a signal strength, a signal reliability measure and an amount of interference from other communication networks.

The first communication interface may be located at a first location on the spa body. The second communication interface may be located at a second location on the spa body spaced apart from the first location. The second location may be at an opposing side of the spa body from the first location. The second location may be a first corner of the spa body. The first location may be a second corner of the spa body, the first corner being opposite to the second corner.

The at least two communication interfaces may include a third communication interface located at a third location on the spa body. The third location may spaced apart from the first location and the second location. At least one of the at least two communication interfaces may include a transceiver. Each of the at least two communication interfaces may include a transceiver.

At least one of the at least two communication interfaces may include a communication port configured to removably receive at least one transceiver. The communication port may be a USB port. The at least one transceiver may be one of a Bluetooth transceiver, a Wi-Fi transceiver, a Wi-Fi-USB transceiver, a cellular transceiver module and a cellular-USB transceiver.

One of the at least two communication interfaces may be positioned at an end of a connector cable. The connector cable may be a USB extension cable.

At least one the first communication interface may be positioned within a cavity formed on a spa shell of the spa body. The cavity may be formed on a corner of the spa shell. A removable cover may enclose the cavity.

In some aspects, the embodiments described herein relate to a bathing unit system including: (a) a spa body including a water receptacle for holding water; (b) a plurality of bathing unit components including at least one heater and a circulation pump, the at least one heater and the circulation pump being installed in a circulation system configured for circulating water to and from the water receptacle; (c) a control system configured to generate control signals to control operational setting of one or more of the plurality of bathing unit components in the bathing unit system including the at least one heater and the circulation pump; (d) a connectivity unit located at a first location on the spa body, the connectivity unit including a first communication device for exchanging information between the control system and an external communication network; and (e) at least one communication port connected to the spa body, the at least one communication port being configured to removably receive a second communication device for exchanging information between the control system and the external communication network.

The first communication device may be fixed relative to the spa body.

The at least one communication port may be a USB port. The at least one communication port may be located at an end of a connector cable.

The at least one communication port may be located at a second location on the spa body. The second location may be a fixed location distinct from and spaced apart from the first location. The at least one communication port may be configured to be moved on the spa body relative to the first location.

A spa shell of the spa body may include a cavity with a removable cover enclosing the cavity. The at least one communication port may be located within the cavity. The cavity may be formed on a corner of the spa shell of the spa body. The removable cover may be shaped to mimic a shape and curvature of other corners of the spa shell of the spa body.

In some aspects, the embodiments described herein relate to a bathing unit system, said bathing unit system further including a processor configured for (a) processing signals originating from the first communication device to derive a specific quality measurement: (i) in response to the specific quality measurement meeting a threshold quality level, using the first communication device to establish a communication link between the control system and the external communication network; or (ii) in response to the specific quality measurement failing to meet the threshold quality level, initiate a process for using a communication device removably received in the at least one communication port to establish the communication link between the control system and the external communication network. The processor may further be configured for (b) exchanging information between the control system and the external communication network over the established communication link.

The process for using a communication device removably received in the at least one communication port may include generating a notification message for a user of the bathing unit system prompting the user to connect the second communication device to the at least one communication port. The plurality of bathing unit components may includes a control panel including a display screen. The notification message may be presented on the display screen. The notification message may presented on a display screen of a device associated with the user.

In some aspects, the embodiments described herein relate to a bathing unit system, said bathing unit system further including a processor configured for (a) processing quality measurements corresponding to signals originating from the first communication device and from the second communication device removably received in the at least one communication port to identify a preferred communication device between the first communication device and the second communication device, the preferred communication device being associated with a quality measurement: (i) exceeding a threshold quality level; and/or (ii) exceeding quality measurements of other signals amongst the signals originating from the first communication device and the second communication device. The processor is further configured for (b) exchanging information between the control system and the external communication network using the preferred communication device.

The quality measurement may include at least one of a signal-to-noise ratio, a signal strength, a signal reliability measure and an amount of interference from other communication networks.

At least one of the first communication device and the second communication device may be one of a Bluetooth transceiver, a Wi-Fi transceiver, a Wi-Fi-USB transceiver, a cellular transceiver and a cellular-USB transceiver.

In some aspects, the embodiments described herein relate to a method of dynamically selecting a communication interface for establishing a communication link between a controller of a bathing unit system and an external communication network, the bathing unit system including a spa body including a water receptacle for holding water, the method including: (a) receiving, at a processor of the bathing unit system, a first signal originating from a first communication interface positioned at a first location on the spa body; (b) receiving, at the processor of the bathing unit system, a second signal originated from a second communication interface positioned at a second location on the spa body; and (c) processing the first signal and the second signal to identify a preferred communication interface between the first communication interface and the second communication interface, the preferred communication interface being associated with signal quality measurements: (i) exceeding a threshold quality level; and/or (ii) exceeding quality measurements of another one of the first communication interface and the second communication interface. The method further includes: (d) using the preferred communication interface to establish the communication link between the controller and the external communication network for exchanging information between the bathing unit system and one of more external devices.

The quality measurements may include at least one of a signal-to-noise ratio, a signal strength, a signal reliability measure and an amount of interference from other communication networks.

Steps (a) to (d) may be repeated at a regular intervals. The regular interval may be one of an hour, a day, a week and a month. Steps (a) to (d) may be repeated in response to a detected use by a user of the bathing unit system.

In some aspects, the embodiments described herein relate to a method of selecting a communication port for establishing a communication link between a controller of a bathing unit system and an external communication network, the bathing unit system including a spa body including a water receptacle for holding water, the method including: (a) receiving, at a processor of the bathing unit system, a first signal originating from a first communication device positioned at a first location on the spa body; (b) prompting a user to provide an indication of test readiness conveying that the first communication device has been repositioned at a second location on the spa body, the second location being distinct from the first location; (c) receiving, at the processor of the bathing unit system, a second signal originating from the first communication device positioned at the second location; and (d) processing the first signal and the second signal to identify a preferred location between the first location and the second location, the preferred location being associated with signal quality measurements: (i) exceeding a threshold quality level; and/or (ii) exceeding quality measurements of another one of the first location and the second location. The method further includes: (e) generating a notification message prompting the user to removably connect the first communication device at the preferred location; and (f) using the first communication device connected at the preferred location to establish the communication link between the controller and the external communication network for exchanging information between the bathing unit system and one of more external devices.

These and other aspects of the disclosure will now become apparent to those of ordinary skill in the art upon review of the following description of embodiments of the disclosure in conjunction with the accompanying drawings.

All features of exemplary embodiments which are described in this disclosure and are not mutually exclusive can be combined with one another. Elements of one embodiment or aspect can be utilized in the other embodiments/aspects without further mention. Other aspects and features of the present invention will become apparent to those ordinarily skilled in the art upon review of the following description of specific embodiments in conjunction with the accompanying Figures.

### BRIEF DESCRIPTION OF THE DRAWINGS

A detailed description of embodiments of the disclosure is provided below, by way of example only, with reference to the accompanying drawings, in which:

FIG. 1 shows a block diagram of a bathing unit system including one or more pump assemblies and having a connectivity unit in accordance with one embodiment;

FIG. 2 shows a more detailed functional block diagram of the control system of FIG. 1 in accordance with a non-limiting example of implementation together with a functional block diagram of an external device;

FIG. 3 illustrates a bathing unit system of FIG. 1 with a connectivity unit in accordance with another embodiment;

FIGS. 4A-C show schematic views from above of different configurations of the connectivity unit of the bathing unit system of FIG. 3 in accordance with different embodiments;

FIG. 5 shows a schematic view from above of a bathing unit system with a connectivity unit in accordance with another embodiment;

FIG. 6 shows a schematic view from above of a bathing unit system with a connectivity unit in accordance with another embodiment;

FIG. 7 shows a schematic view from above of a bathing unit system with a connectivity unit in accordance with another embodiment;

FIG. 8 shows a schematic view from above of a bathing unit system with a connectivity unit in accordance with another embodiment;

FIG. 9 is a flowchart of a process for evaluating a signal executed using the control system of FIG. 2 in accordance with one embodiment;

FIG. 10 is a flowchart of a process for evaluating a location executed using the control system of FIG. 2 in accordance with one embodiment;

FIG. 11 is a user interface conveying a prompts regarding a communication device and/or a communication interface of a bathing unit system in accordance with one embodiment, the user interface displayed on a device associated with a user of the bathing unit system.

FIG. 12 is a flowchart of a process for evaluating a communication device executed using the control system of FIG. 2 in accordance with one embodiment;

FIGS. 13A-C show a bathing unit system with communication interfaces covered with a cover in accordance with one embodiment;

FIGS. 14A-C shows example implementations of the communication devices to be used with the bathing unit system of FIGS. 13A-C; and

In the drawings, the embodiments of the disclosure are illustrated by way of examples. It is to be expressly understood that the description and drawings are only for the purpose of illustration and are an aid for understanding. They are not intended to be a definition of the limits of the disclosure.

### DETAILED DESCRIPTION

Specific examples of implementation of the disclosure will now be described with reference to the Figures.

The description below is directed to specific implementations of providing network connectivity in the context of a bathing unit system. It is to be understood that the terms “bathing system” or “bathing unit system”, as used for the purposes of the present description, are used interchangeably and refer to spas, whirlpools, hot tubs, bathtubs, therapeutic baths, swimming pools and any other type of bathing unit that can be equipped with a pump assembly (including, e.g., a circulation pump) for circulating water to and from a tub or water receptacle.

### Bathing Unit System Overview

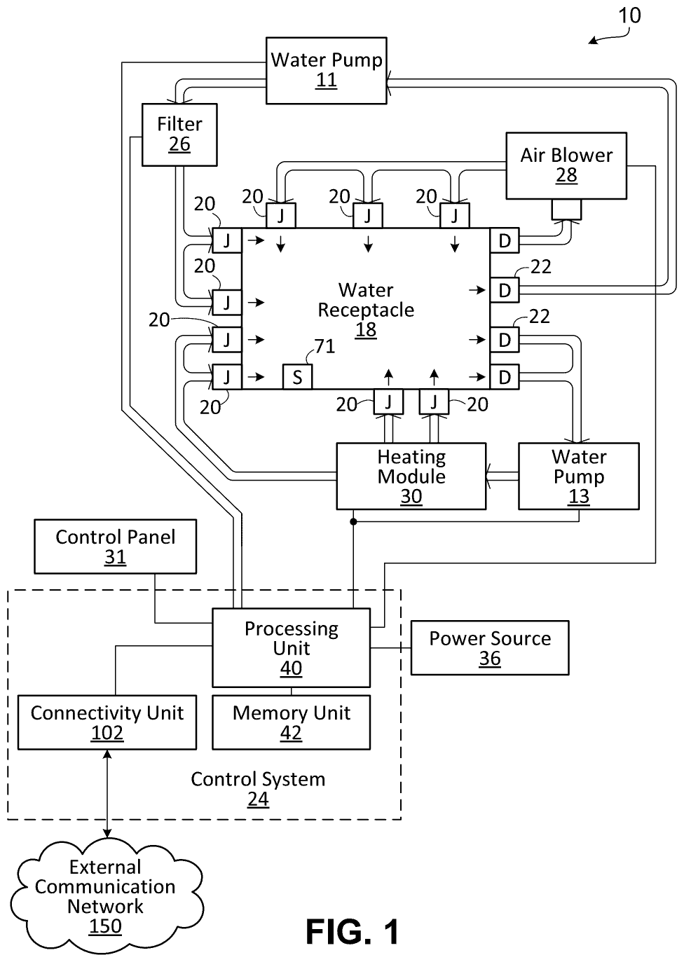

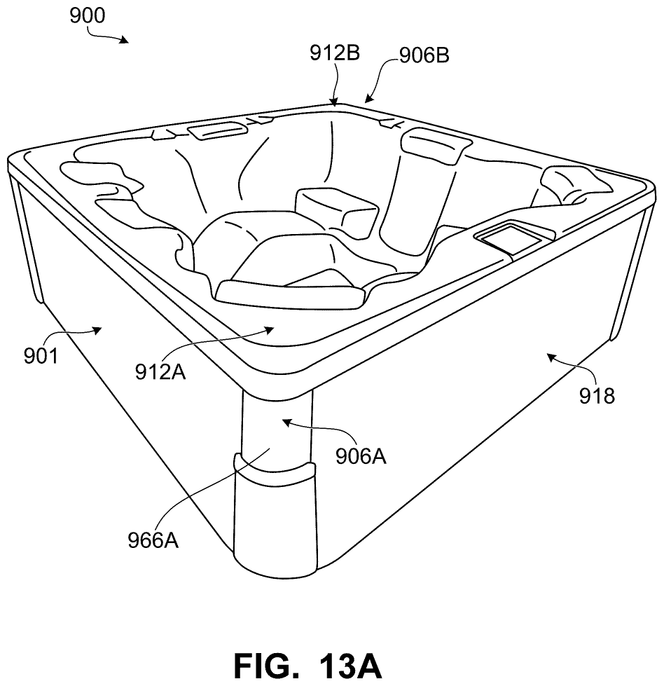

FIG. 1 is a block diagram of a bathing unit system 10 in accordance with one embodiment of the present disclosure. The bathing unit system 10 includes a water receptacle 18 for holding water, a spa shell, a plurality of jets 20, a set of drains 22 and a control system 24. In the illustrative example shown in FIG. 1, the bathing unit system 10 includes bathing unit components including a heating module 30, two water pumps 11 and 13, a filter 26 and an air blower 28. The bathing unit system 10 can include more or fewer bathing unit components. For example, the heating module 30 may be one of at least one heater of the bathing unit system 10; the at least one heater may include the heating module 30 as a main heater, a separate heating module (not shown) as an auxiliary heater and a third heating module (not shown) which may be a heat pump configured to assist the main heating module 30 and/or the auxiliary heating module to heat and/or cool the water in the water receptacle 18. As an additional example, the two water pumps 11 and 13 may be a circulation pump, a jet pump, etc. As a still further example, although not shown in FIG. 11, the bathing unit system 10 could include an ozonator, a lighting system for lighting up the water in the water receptacle 18, multimedia devices such as an MP3 player, a CD/DVD player as well as other suitable devices.

In the non-limiting embodiment shown, the control system 24 includes a processing unit 40. The processing unit 40 may control one or more of the bathing unit components 11, 13, 26, 28, 30. The processing unit 40 may also coordinate interactions between the bathing unit components 11, 13, 26, 28 and 30, the control system 24, an external communication network 150, a power source 36 and a control panel 31. In the embodiment shown in FIG. 1, the processing unit 40 is shown as a single device. One of ordinary skill in the art will recognize that it is possible to control some of the bathing unit components 11, 13, 26, 28, 30 and coordinate interaction between the bathing unit components 11, 13, 26, 28, 30 and the power source 36 using one device (e.g., a pack) and coordinate interactions between the control system 24, the control panel 31 and the external communication network 150 using another device (e.g., a central processor).

The user control panel 31 enables a user to enter user commands for the control system 24. In a specific embodiment, the user control panel 31 includes a display screen and a user input device (which can also be referred to as a user operable input). The user input device can include a trackball, mouse, gyroscope remote (which senses movement of the device in the air so as to move a cursor), a keypad, a touch sensitive screen, turn-dials, turn-and-push dials (such as iDrive™ from BMW™), a stylus pen or a microphone, among other possibilities. The user input device can include one or a combination of any or all of the above input devices. The user control panel 31 can be a top-side control panel positioned on the outer shell of the water receptacle 18.

The user control panel 31 provides an interface that allows a user to enter commands for causing the control system 24 to control the various operational settings of one or more of the bathing unit components 11, 13, 26, 28, 30. Some non-limiting examples of operational settings include temperature control settings, jet control settings, and lighting settings, among other possibilities. In a non-limiting embodiment where the bathing unit system 10 is connected to entertainment and/or multimedia modules, the operational settings of the bathing unit system 10 may also include audio settings and video settings, amongst others. The expression “operational settings”, for the purpose of the present disclosure, is intended to cover operational settings for any suitable bathing unit component or components that can be operated by a user of the bathing unit system 10.

In normal operation, water flows from the water receptacle 18, through the drains 22 and is pumped by water pump 13 through the heating module 30 where the water is heated. The heated water then leaves the heating module 30 and re-enters the water receptacle 18 through the jets 20. In addition, water flows from the water receptacle 18, through different drains 22 and is pumped by the water pump 11 through the filter 26. The filtered water then re-enters the water receptacle 18 through different jets 20. Water can flow through these two cycles continuously while the bathing unit system 10 is in operation. Optionally, water can also flow from the water receptacle 18 through one or more drains 22 to the air blower 28 that is operative for delivering air bubbles to water that re-enters the water receptacle 18 through jets 20.

In the embodiment shown, the control system 24 may receive electrical power from the power source 36 that is connected thereto via service wiring 51, e.g., an electric power source. The power source 36 supplies the control system 24 with any conventional power service suitable for residential or commercial use. In other embodiments, the control system 24 may receive electrical power from a battery, solar panel, or any other electrical power source.

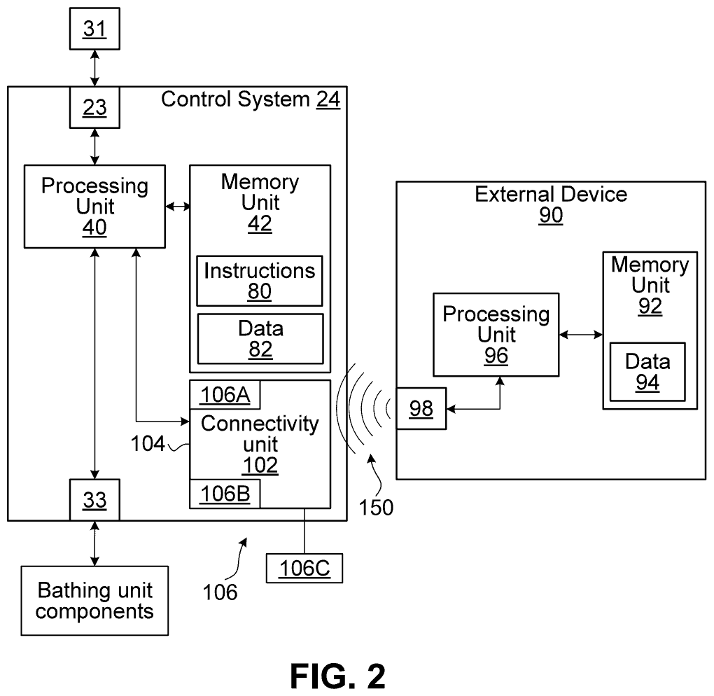

The processing unit 40 (e.g., a portion of the processing unit 40 implemented as a pack) may control the distribution of power supplied to the various bathing unit components 11, 13, 26, 28, 30. The processing unit 40 may also cause desired operational settings of the bathing unit components 11, 13, 26, 28 and 30 to be implemented on the basis of program instructions and signals received from the user control panel 31 or from one or more external devices 90 (shown in FIG. 2) external to the bathing unit system 10 through the external communication network 150. The processing unit 40 may also receive control signals from various sensors to cause the desired operational settings to be implemented. Manners in which the processing unit 40 can be used to control the individual bathing unit components of the bathing unit system 10, such as for example the jets 20, the drains 22, the heating module 30, the water pumps 11 and 13, the filter 26, the air blower 28, a valve jet sequencer for massage, a pump with a pre-programmed massage setting, a water fall, an aroma therapy device and an atomizer, as well as any lighting and multimedia components, are known in the art and as such will not be described in further detail here.

Referring to FIGS. 1 and 2, in the embodiment shown, the control system 24 includes the processing unit 40, a memory unit 42, and a connectivity unit 102, all in communication with the processing unit 40. Referring to FIG. 2, the processing unit 40 may be in communication with the control panel 31 through I/O interface 23 and in communication with other bathing unit components 11, 13, 26, 28, 30 via I/O interface 33. Other embodiments of the control system 24 may include fewer, additional or alternative components. Additionally, although only a single processing unit 40, a single memory unit 42, and a single connectivity unit 102 are shown in FIG. 2, other embodiments of the control system 24 may include more than one of each of these components.

The memory unit 42 stores program instructions 80 and data 82 for use by the processing unit 40. The data 82 stored in the memory unit 42 includes, amongst others, information conveying the operational settings associated with bathing unit components in the bathing unit system 10. For example, the operational settings may include temperature control settings, jet control settings, and lighting settings, among other possibilities. The memory unit 42 may also store water temperature information conveying water temperature measurements for water in the water receptacle 18. The program instructions 80 stored in the memory unit 42 may include various blocks of code (alternatively called processor-executable instructions and/or computer-executable instructions) for directing the processing unit 40 to perform various processes to provide network-related functionality which will be described in greater detail below, such as a signal evaluation process 600, a location evaluation process 700, and a communication device evaluation process 750 as described below. In other embodiments, the program instructions 80 stored in the memory unit 42 may store fewer, additional or alternative codes directing the processing unit 40 to execute additional or alternative processes. For example, the program instructions 80 may include codes directing the processing unit 40 to control various operational settings associated with the bathing unit system 10 at least in part based on those program instructions 80 in combination with signals received from one or more external devices 90 and/or based on commands received from a user via the control panel 31. The program instructions 80 may also include codes directing the processing unit 40 to implement at least some functions of the control panel 31. For example, the program instructions 80 may implement a menu driven interface through which a user can navigate and be presented on a display of the control panel 31. Alternatively, functions pertaining to the control panel 31 may be implemented by a separate processor associated specifically with the control panel 31.

The memory unit 42 may be implemented as one or a combination of a non-transitory computer-readable medium and/or non-transitory machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching thereof). The expression “non-transitory computer-readable medium” or “non-transitory machine-readable medium” as used herein is defined to include any type of computer-readable storage device and/or storage disk and to exclude propagating signals and to exclude transmission media.

The connectivity unit 102 is configured to allow the control system 24 to interface with the external communication network 150 to communicate with the one or more external devices 90. The connectivity unit 102 may be of any suitable type known in the art, including a wireless interface and wired interface. In a non-limiting implementation, the connectivity unit 102 includes at least one communication interface 106 which enables the control system 24 to communicate over the external communication network 150 using a wireless communication protocol such as wireless local area network protocols (e.g., Wi-Fi), wide area network protocols (e.g., cellular, 3G, 4G, 5G, LTE, etc.) radio frequency (RF), Bluetooth, Zigbee, etc. For example, as described below, the connectivity unit 102 may be, may include, or may be configured removably receive at least one communication device. The at least one communication device may be a transmitter, a receiver and/or a transceiver suitable for transmitting and receiving signals in a Wi-Fi network or over a cellular network (e.g., 3G, 4G, 5G, LTE, etc.). In other embodiments, the at least one communication device may comprise any suitable device for transmitting and receiving information over the external communication network 150, including a communication device configured to communicate using power line transmission, low power long range transmission (ex: LoRa, Sigfox), etc.

The external device 90 and the control system 24 may configured to establish a communication link using the external communication network 150 to enabling the control system 24 to receive information from, and/or transmit information to, the external device 90. One example embodiment of the external device 90 is shown in FIG. 2. In particular, the external device 90 may be configured for transmitting information that may be stored in a memory 92 of the external device 90. The memory 92 of the external device 90 may also store suitable instructions, which when executed by processing unit 96, allow for the transmittal of information to the control system 24 over the external communication network 150. In the embodiment shown, the external communication network 150 comprises a wireless network; however, one of ordinary skill in the art will recognize that the external communication network 150 may be a wired network.

### Connectivity Unit 102

FIG. 2 illustrates an exemplary embodiment of the connectivity unit 102. In some examples, the connectivity unit 102 is enclosed in a housing 104. The housing 104 can be a solid casing that encloses the parts therein. The housing 104 can be adapted to attach to a wall or body of the water receptacle 18, e.g., the housing 104 can be adapted to be positioned within a spa cabinet of the bathing unit system 10, may be positioned under a flange associated with the water receptacle 18, etc.

In the embodiment shown in FIGS. 1 and 2, the connectivity unit 102 is coupled with the processing unit 40, to coordinate interactions between the control system 24 and the one or more external devices 90 over the external communication network 150. However, in other embodiments, the connectivity unit 102 may instead be coupled with the user control panel 31 or directly with various ones of the bathing unit components 11, 13, 26, 28, 30, to coordinate interactions between these components and the one or more external devices 90 over the external communication network 150.

The connectivity unit 102 includes the at least one communication interface 106 which enables the control system 24 to communicate over the external communication network 150 with the at least one external device. In the embodiment shown in FIG. 2, the at least one communication interface 106 includes three communication interfaces 106A, 106B and 106C; in other embodiments, more or fewer communication interfaces 106 are possible. As used herein, “communication interface” may comprise communication ports configured to receive at least one communication device or may include, or be, the at least one communication device.

The communication interfaces 106 may be located at different locations relative to the connectivity unit 102. For example, at least one communication interface 106 may be internal to the housing 104 (e.g., located at an internal location within the housing 104, such as the interfaces 106A and 106B). Additionally or alternatively, at least one communication interface 106 may be external to the housing 104 (e.g., located at an external location outside of the housing 104, such as the interface 106C). The communication interfaces may also be located on or proximate different structural components of the bathing unit system 10 as will be described below. For example, at least one communication interface 106 may be located on a corner of a spa body of the bathing unit system 10. Additionally or alternatively, at least one communication interface 106 may be located on a sidewall of the spa body. Positioning the communication interfaces 106 on the corners or the sidewalls of the spa body can allow the communication interfaces 106 to be positioned around at outer edges of the bathing unit system 10 and in an area which is relatively unobstructed by other structural components of the spa body (e.g., cabinet insulation, the spa cover, structural panels of a spa cabinet, the water receptacle 18). This can increase the likelihood that, when the bathing unit system 10 is installed at the field location, there is at least one communication interface 106 positioned close enough to a source of network signal such that a communication device of the at least one communication interface 106 is capable of receiving a sufficiently strong signal from the source of the network signals.

The communication interfaces 106 may be fixed or may be movable relative to the housing 104. For example, the communication interfaces 106A and 106B may be fixed and immovable relative to the housing 104. Additionally or alternatively, the communication interface 106C may be movable to different locations on the spa body.

As described above, the communication interfaces 106 may be configured to receive the at least one communication device. For example, at least one communication interface 106 may comprise communication ports such as USB ports, RS-485 ports for accessories that do not require high-speed communication, ports for an RJ-45 (ethernet) connector, or any other type of port operable to receive at least one communication device. In some embodiments, the communication ports may be configured to removably receive the at least one communication device; however, in other embodiments, the communication ports may be configured to permanently receive the at least one communication device.

The communication devices may include various transmitters, receivers, and transceivers that enable the control system 24 to communicate with the one or more external devices 90 over the external communication network 150. As described above, these communication devices may enable the control system 24 to communicate over the external communication network 150 using a wireless communication protocol such as wireless local area network protocols (e.g., Wi-Fi), wide area network protocols (e.g., cellular, 3G, 4G, 5G, LTE, etc.), RF, Bluetooth, Zigbee, etc. For example, the communication device may be a Wi-F transceiver, a cellular transceiver (e.g., 3G, 4G, 5G, LTE, etc.), a Bluetooth transceiver (e.g., Bluetooth or Bluetooth low energy (LE)), satellite transceivers, and RF transceivers. Additionally or alternatively, the communication device may be alternative communication devices, such as different antennas (e.g., type F antennas or bipole antennas for Wi-Fi communication), fiber-optic transceivers, etc. As also described above, the communication interfaces 106 may include, or be, the at least one communication device. For example, at least one communication interface 106 may itself be a transmitter, a receiver, and/or a transceiver which enables the control system 24 to communicate with the one or more external devices 90 over the external communication network 150.

As a specific embodiment, the communication interface 106B may be a communication port for receiving a Wi-F transceiver, a cellular transceiver, a Bluetooth transceiver, a satellite transceiver, and/or a RF transceiver. As another specific embodiment, the communication interface 106A and 106B may itself be a Wi-F transceiver, a cellular transceiver, a Bluetooth transceiver, a satellite transceiver, and/or a RF transceiver.

In other embodiments, the communication interfaces 106 may include ports configured to removably receive, or to otherwise couple, the control system 24 to other devices, including one or more of the bathing unit components 11, 13, 26, 28, 30, the user control panel 31, the power source 36, etc. In such embodiments, processor unit 40 may be coupled to one or more of the bathing unit components 11, 13, 26, 28, 30 and/or the user control panel 31 via the connectivity unit 102, rather than via the I/O ports 33 and 23 shown in FIG. 2.

### Communication Interface 106 Configurations and Locations

The connectivity unit 102 shown in FIG. 2 can be configured in different ways to overcome problems due to different signal strengths at different locations on the bathing unit system 10. Such differences in signal strength may be due to the water in the water receptacle 18 to which the connectivity unit 102 is adjacent, as water may attenuate signal strength of wireless signals. Such differences in signal strength may also be due to a distance between the communication interface 106 and a source of the wireless signals, such as a Wi-Fi router or a cellular tower, as distance may also attenuate signal strength of wireless signals. These configurations of the connectivity unit 102 may include more than one (e.g., at least two) communication interface 106 which may be positioned at different locations on the bathing unit system 10. The connectivity unit 102 may also be configured so that different communication devices (different types or different ranges) may be removably received in a communication interface 106. The connectivity unit 102 may also be configured such that a communication interface 106 is movable to different locations on the bathing unit system 10. The inclusion of more than one communication interface 106, the ability to use change communication devices and/or the use of a communication interface 106 which may be movable can increase the likelihood that, when the bathing unit system 10 is installed at a field location, there is at least one communication interface 106 positioned (or movable) close enough to a source of network signals for receiving, and/or at least one communication device which is capable of receiving, a sufficiently strong signal from the source of the network. In particular, the inclusion of more than one communication interface 106 and/or the use of a communication interface 106 which may be movable can increase the likelihood that there is at least one communication interface 106 positioned (or movable) to a location on the bathing unit system 10 without the water in the water receptacle 18 being positioned between the communication interface 106 and the source of the wireless signals.

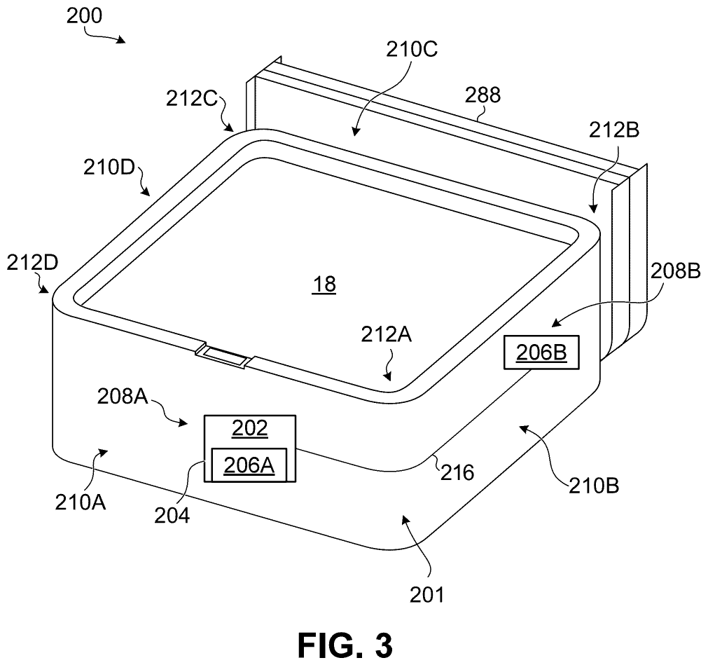

FIG. 3 illustrates one implementation of a bathing unit system 200 including more than one communication interface 106. The bathing unit system 200 may be similar to, correspond to, or be one implementation of, the bathing unit system 10 shown in FIGS. 1 and 2. The bathing unit system 200 includes a spa body 201 including the water receptacle 18. In the embodiment shown, the spa body 201 is illustrated as including a first sidewall 210A, a second sidewall 210B, a third sidewall 210C and a fourth sidewall 210D. Further, in the embodiment shown, the sidewalls 210A, 210B, 210C and 210D are joined at corresponding corners, including corner 212A at a juncture of the first and second sidewalls 210A and 210B, corner 212B at a juncture of the second and third sidewalls 210B and 210C, corner 212C at a juncture of the third and fourth sidewall 210C and 210D, and corner 212D at a juncture of the fourth and first sidewalls 210D and 210A. Each of the different sidewalls 210A, 210B, 210C and 210D and the different corners 212A, 212B, 212C and 212D may generally be considered different “structural components” of the spa body 201 and the bathing unit system 200. However, one of ordinary skill in the art will recognize that other configurations of the bathing unit system 200 are possible, including a circular water receptacle (e.g., including a substantially continuous circumferential sidewall, with no corners), a triangular water receptacle (e.g., including three sidewalls and three corresponding corners), a polygonal water receptacle (e.g., a hexagon, pentagon, octagon, etc., including corresponding numbers of sidewalls), etc. Further, one of ordinary skill in the art will recognize that the bathing unit system 200 may include alternative or additional structural components of the bathing unit system 200 including a bottom wall of the water receptacle 18, a spa cover 288, a spa cabinet substantially enclosing the water receptacle 18, etc.

In the configuration shown in FIG. 3, the bathing unit system 200 includes a connectivity unit 202. The connectivity unit 202 may be similar to, correspond to, or being one implementation, the connectivity unit 102 shown in FIGS. 1 and 2. The connectivity unit 202 includes a first internal interface 206A (e.g., as one of the communication interfaces 106 shown in FIG. 2) installed directly in the connectivity unit 202 (e.g., within a housing 204 of the connectivity unit 202). The connectivity unit 202 is installed at a first location 208A on the bathing unit system 200, and as a result, the first internal interface 206A is also positioned at first location 208A. Further, the connectivity unit 202 also includes a second external interface 206B (e.g., as another one of the communication interfaces 106 shown in FIG. 2) coupled to the connectivity unit 202 via a wired connection or connector cable 216 and located outside of the housing 204 of the connectivity unit 202. The second external interface 206B is located at a second location 208B on the bathing unit system 200.

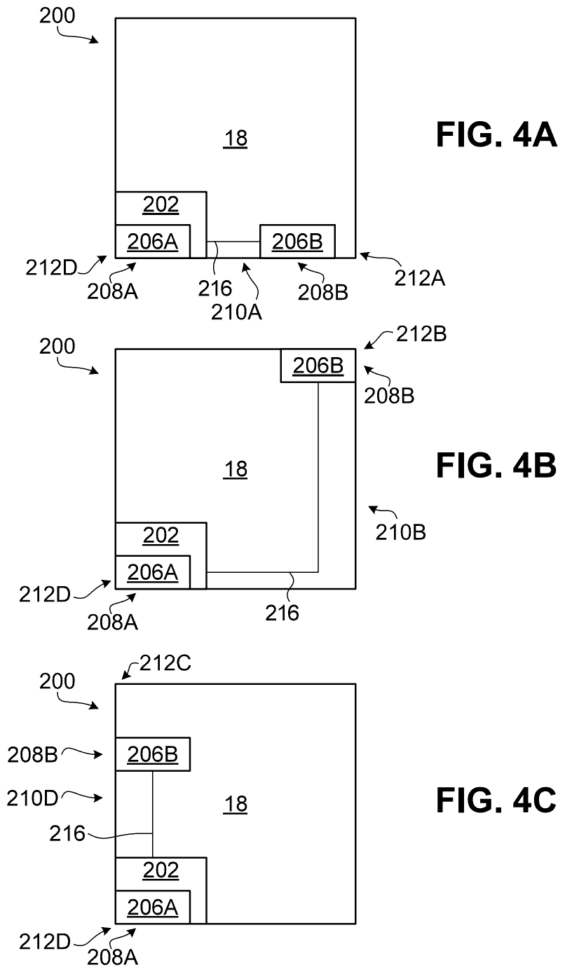

The first and second locations 208A and 208B may be distinct from and spaced apart from each other. For example, the first and second locations 208A and 208B may be located at, or proximate, different structural components of the spa body 201 (e.g., different ones of the sidewalls 210A, 210B, 210C and 210D, the corners 212A, 212B, 212C and 212D, the bottom wall of the water receptacle 18, etc.). In the embodiment shown in FIG. 3, the first location 208A is at or proximate the first sidewall 210A, while the second location 208B is at or proximate the second sidewall 210B. In other embodiments, the first location 208A may be at the first sidewall 210A, while the second location 208B is at or proximate the corner 212A, the second sidewall 210B, the corner 212B, the third sidewall 210C, the corner 212C, the fourth sidewall 210D, the corner 212D, etc. However, in other embodiments, the first and second locations 208A and 208B may also be located at, or proximate, a same structural component of the spa body 201, while still being spaced apart from each other. For example, the first and second locations 208A and 208B may both be located at the first sidewall 210A, however, the first location 208A may be proximate the corner 212D, while the second location 208B may be proximate the corner 212A instead. Different embodiments of the first and second interfaces 206A and 206B being positioned at different first and second locations 208A and 208B are described below in association with FIGS. 4A-4C.

As described above, at least one of the first and second interfaces 206A and 206B may comprise communication ports configured to removably or permanently receive at least one communication device. For example, the second external interface 206B may comprise a communication port configured to removably receive at least one communication device, and may be a communication port configured to removably receive a Wi-Fi-USB transceiver module, an LTE-M transceiver module, or an LTE-USB transceiver module. The connector cable 216 may be a USB extension cable. In this regard, at least one of the second interface 206B may be configured to accept more than one type of communication device. At least one of the first and second interfaces 206A and 206B may comprise, or be, the at least one communication device itself. For example, the first internal interface 206A may be the communication device itself, and may be a Bluetooth transceiver and/or a Wi-Fi transceiver

FIG. 4A shows a schematic view of the bathing unit system 200 of FIG. 3 in accordance with another embodiment, where the first location 208A of the first internal interface 206A is positioned at or proximate the corner 212D, while the second location 208B of the second external interface 206B is at or proximate the first sidewall 210A and may further be closer to the corner 212A rather than the corner 212D.

FIG. 4B shows a schematic view of the bathing unit system 200 of FIG. 3 in accordance with another embodiment, where the first location 208A of the first internal interface 206A is positioned at or proximate the corner 212D, while the second location 208B of the second external interface 206B is at or proximate the corner 212B. In this embodiment, the first and second locations 208A and 208B are positioned on opposing structural components of the bathing unit system 200, namely structural components which oppose each other on the bathing unit system 200 (on opposite sides of the bathing unit system 200, e.g., the corners 212D and 212B, the corners 212A and 212C, the first and third sidewalls 210A and 210C, and the second and fourth sidewall 210B and 210D). Placing the first and second locations 208A and 208B on opposing structural components can increase the likelihood that, regardless of installation configuration at the field location, there is at least one communication interface 106 (a) positioned close enough to the source of network signals for receiving a sufficiently strong signal and (b) positioned at a location where the water in the water receptacle 18 is not between that communication interface 106 and the source of the wireless signals. For example, if the bathing unit system 200 is installed at the field location such that the second sidewall 210B is positioned closest to a house (and a Wi-Fi router source of network signals), the second external interface 206B at the second location 208B is positioned close to the house and is also positioned such that the water in the receptacle 18 is not between the house and the second external interface 206B.

FIG. 4C shows a schematic view of the bathing unit system 200 of FIG. 3 in accordance with another embodiment, where the first location 208A of the first internal interface 206A is positioned at or proximate the corner 212D, while the second location 208B of the second external interface 206B is at or proximate the fourth sidewall 210D and may further be closer to the corner 212C than the corner 212D.

In some embodiments, at least one of the first and second interfaces 206A and 206B may be fixed and immovable relative to the spa body 201 and each other. For example, during manufacture, the first internal interface 206A within the connectivity unit 202 is positioned and fixed at the first location 208A at or proximate to the corner 212D. In some embodiments, the second external interface 206B may be fixed at the second location 208B as well.

However, in other embodiments, at least one of the first and second interfaces 206A and 206B may be movable relative to the spa body and/or relative to each other. For example, the second external interface 206B may be movable to different structural components of the spa body 201. In this regard, the connector cable 216 may have a length dimension sufficient to enable—or a configuration which otherwise enables (e.g., configured to be removably received in different ports of the connectivity unit 202)—a user (e.g., a technician or the owner of the bathing unit system 200) to move the second external interface 206B to any appropriate second location 208B on the spa body 201. For example, during manufacture, the second external interface 206B may be positioned at the second location 208B at or proximate to the first sidewall 210A closer to the corner 212A rather than the corner 212D (as shown in FIG. 4A). However, after the bathing unit system 200 is installed at the field location, the user may move the second external interface 206B to the second location 208B at or proximate to the corner 212B (as shown in FIG. 4B) or at or proximate to the fourth sidewall 210D closer to the corner 212C rather than the corner 212D (as shown in FIG. 4C). One of ordinary skill in the art will recognize that the second external interface 206B may be positioned on alternative structural components of the bathing unit system 200 than those described above. The second external interface 206B may be fastened to the structural component of the bathing unit system 200 by any means known in the art, e.g., by clip, hook and loop fastener, etc. In some embodiments, the first internal interface 206A (e.g., alone or as a part of the entire connectivity unit 202) may also be movable relative to the bathing unit system 200 and/or relative to the second external interface 206B.

Movement of the at least one of the first and second interfaces 206A and 206B can allow the user to maximize the signal strength from the source of the wireless signal and to maximize connectivity as between the connectivity unit 202 and the external communication network 150 based on the actual environment at the field location of the bathing unit system 200 after installation. For example, as noted above, the configuration shown in FIG. 4A may be a first configuration of the connectivity unit 102 during manufacture. However, if the user (or the control system 24) determines that the signal quality of the wireless signal being received by connectivity unit 202 (e.g., as determined via the signal quality measurements described below) is low (e.g., below a threshold quality level), the user may (or may be prompted to) move the second external interface 206B as described below in association with the signal evaluation process 600 or the location evaluation process 700. For example, the user may (or may be prompted to) move the second external interface 206B to the corner 212B (e.g., the configuration shown in FIG. 4B) and/or to the fourth sidewall 210D proximate the corner 212C (e.g., the configuration shown in FIG. 4C). The user may (or may be prompted to) move the second external interface 206B more than once until the signal quality of the wireless signal is deemed acceptable (e.g., above the threshold quality level).

Additionally or alternatively, the communication device forming, or received in, at least one of the first internal interface 206A and the second external interface 206B may be changed from a first communication device to a second communication device. The second communication device may improve signal quality of the wireless signal received by the connectivity unit 202 over the external communication network 150. For example, as described above, in some embodiments, the external interface 206B may be a communication port configured to removably receive a first communication device. The first communication device may be a Wi-Fi transceiver module when the connectivity unit 102 is manufactured. However, if the user (or the control system 24) determines that the signal quality of the wireless signal being received by the connectivity unit 202 is low (e.g., below a threshold quality level), the user may (or may be prompted to) switch the first communication device for the second communication device. The second communication device may be another type of transceiver which allows communication over another network (e.g., a cellular network rather than a Wi-Fi network), such as a LTE-M transceiver module or an LTE-USB transceiver module. Additionally or alternatively, the second communication device may also be a more powerful, longer-range, or different frequency transceiver which allows communication over the same network or a different network (e.g., a Wi-Fi 6 transceiver module rather than a Wi-Fi-five transceiver module). In some embodiments, the communication device forming the first internal interface 206A may also be switched for another communication device.

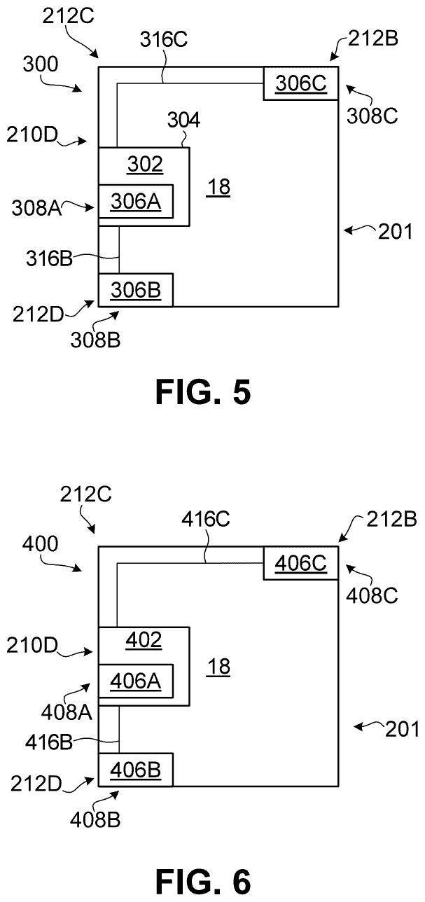

FIG. 5 illustrates another implementation of a bathing unit system 300 including more than one communication interface 106. The bathing unit system 300 may be similar to, correspond to, or be one implementation of, the bathing unit system 10 shown in FIGS. 1 and 2. The bathing unit system 300 comprises the spa body 201 including the water receptacle 18, whereby the spa body 201 includes structural components including the sidewalls 210A, 210B, 210C and 210D and the corners 212A, 212B, 212C and 212D (shown in FIG. 3).

In the configuration shown in FIG. 5, the bathing unit system 300 includes a connectivity unit 302. The connectivity unit 302 may be similar to, correspond to, or being one implementation, the connectivity unit 102 shown in FIGS. 1 and 2. The connectivity unit 302 includes a first internal interface 306A (e.g., as one of the communication interfaces 106 shown in FIG. 2) installed directly in the connectivity unit 302 (e.g., within a housing 304 of the connectivity unit 202). The connectivity unit 302 is installed at a first location 308A, and as a result, the first internal interface 306A is also positioned at the first location 308A. Further, the connectivity unit 302 also includes a second external interface 306B and a third external interface 306C (e.g., as other ones of the communication interfaces 106 shown in FIG. 2) coupled to the connectivity unit 302 via respective connector cables 316B and 316C (e.g., located outside of the housing 304 of the connectivity unit 302). The second and third external interfaces 306B and 306C may be located at, respectively, a second location 308B and a third location 308C on the spa body 201.

The first, second and third locations 308A, 308B, and 308C may all be distinct from and spaced apart from each other. For example, the first, second and third locations 308A, 308B, and 308C may be located at, or proximate, different structural components of the spa body 201. In the embodiment shown in FIG. 5, the first location 308A is at or proximate to the fourth sidewall 210D; the second location 308B is at or proximate the corner 212D; and the third location 308C is at or proximate the corner 212B. The second and third locations 308B and 308C are positioned on opposing structural components of the bathing unit system 300 (e.g., the corners 212B and 212D oppose each other). In other embodiments, the first, second and third locations 308A, 308B and 308C may also be located at or proximate a same structural component of the spa body 201 while still being spaced apart from each other. For example, the first, second and third locations 308A, 308B and 308C may all be located at or proximate the fourth sidewall 210D, but the first location 308A may be at a middle of the fourth sidewall 210D, the second location 308B may be located closer to the corner 212D while the third location 308C may be located closer to the corner 212C.

Similar to the first and second interfaces 206A and 206B (of the bathing unit system 200 shown in FIGS. 3 and 4A-4C), in some embodiments, at least one of the first, second and third interfaces 306A, 306B, and 306C may be fixed and immovable relative to the spa body 201 and each other. For example, the first internal interface 306A may be fixed at the first location 308A. In other embodiments, at least one of the first, second and third interfaces 306A, 306B, and 306C may be movable on the spa body 201 and relative to each other. For example, at least one of the second and third interfaces 306B and 306C may be movable to different structural components of the spa body 201 in a manner similar to the second external interface 206B (of the bathing unit system 200 shown in FIGS. 3 and 4A-4C) described above.

Also similar to the first and second interfaces 206A and 206B of the bathing unit system 200, in some embodiments, the communication device forming, or received in, at least one of the first internal interface 306A, the second external interface 306B and the third external interface 306C may be changed from a first communication device to a second communication device. The second communication device may be another type of transceiver which allows communication over a different network (e.g., over a cellular network rather than a Wi-Fi network). Additionally or alternatively, the second communication device may also be a more powerful, longer-range, or different frequency transceiver which allows for longer-range communications over a same network or a different network (e.g., a Wi-Fi 6 transceiver module rather than a Wi-Fi-five transceiver module). For example, the first internal interface 306A may include a Bluetooth transceiver and/or a Wi-Fi transceiver; the second external interface 306B may be, or may be operable to receive, a Wi-Fi-USB transceiver module or a LTE-USB transceiver module; similarly, the third external interface 306C may be, or may be operable to receive, a Wi-Fi-USB transceiver module or a LTE-USB transceiver module.

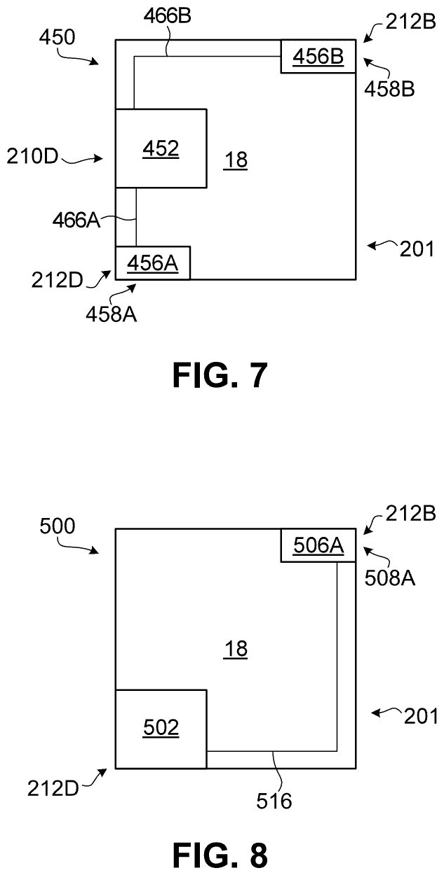

FIG. 6 illustrates another implementation of a bathing unit system 400 including more than one communication interface 106. The bathing unit system 400 may be similar to, correspond to, or be one implementation of, the bathing unit system 10 shown in FIGS. 1 and 2. The bathing unit system 400 comprises the spa body 201 including the water receptacle 18, whereby the spa body 201 includes structural components including the sidewalls 210A, 210B, 210C and 210D and the corners 212A, 212B, 212C and 212D (shown in FIG. 3).

The bathing unit system 400 includes a connectivity unit 402. The connectivity unit 402 may be similar to, correspond to, or be one implementation of, the connectivity unit 102 shown in FIGS. 1 and 2. The connectivity unit 402 includes a first internal interface 406A installed directly in the connectivity unit 402 and positioned at a first location 408A. Further, the connectivity unit 402 also includes a second external interface 406B and a third external interface 406C coupled to the connectivity unit 402 via respective connector cables 416B and 416C. In some embodiments (not shown) the second and third interfaces 406B and 406C may also be coupled to each other. The second and third external interfaces 406B and 406C may be positioned at respective a second and third locations 408B and 408C on the spa body 201.

The first, second and third locations 408A, 408B, and 408C may all be distinct from and spaced apart from each other. For example, the first, second and third locations 408A, 408B, and 408C may be located at, or proximate, different structural components of the spa body 201. In the embodiment shown in FIG. 6, the first location 408A is at or proximate to the fourth sidewall 210D; the second location 408B is at or proximate the corner 212D; and the third location 408C is at or proximate the corner 212B. As such, the second and third locations 408B and 408C are positioned on opposing structural components (e.g., opposite sides) of the bathing unit system 200. However, one of ordinary skill in the art will recognize that the first, second and third locations 408A, 408B and 408C may be on alternative structural components of the spa body 201. In other embodiments, the first, second and third locations 408A, 408B and 408C may also be located at or proximate a same structural component of the spa body 201 while still being spaced apart from each other.

The first, second and third interfaces 406A, 406B and 406C may be fixed and immovable relative to the spa body 201 and each other. More specifically, the first internal interface 406A may be fixed at the first location 408A; the second external interface 406B may be fixed at the second location 408B; and the third external interface 406C may be fixed at the third location 408C.

At least one of the first, second and third interfaces 406A, 406B and 406C may each comprise communication ports which are each configured to removably receive at least one communication device; however, no communication device may be permanently received in any of the first, second and third interfaces 406A, 406B and 406C and thus no communication device is permanently located at any of the first, second and third locations 408A, 408B and 408C locations. The communication ports forming the first, second and third interfaces 406A, 406B, 406C may be, for example, USB ports, antenna ports, RS-485 ports, ethernet ports, or any other type of port operable to receive at least one communication device.

A manufacturer of the bathing unit system 400 may provide at least one communication device with the bathing unit system 400. The at least one communication device may be a Wi-Fi transceiver module (e.g., Wi-Fi-USB transceiver module, a Wi-Fi 6 transceiver module, a Wi-Fi 5 transceiver module, etc.) and/or a LTE transceiver module (e.g., a LTE-M transceiver module, an LTE-USB transceiver module, a 5G transceiver module, a 3G transceiver module, etc.). After the bathing unit system 400 is installed at the field location, the user (or the control system 24) may determine that the signal quality of the wireless signal being received by the connectivity unit 402 is strongest at a preferred location of at one of the first, second and third locations 408A, 408B and 408C. The user may then insert (or be prompted to insert) the at least one communication device into the corresponding preferred communication interface (e.g., a preferred interface of the first, second and third interfaces 406A, 406B, 406C) at the preferred location. Additionally or alternatively, the user (or the control system 24) may determine that the signal quality of the wireless signal is strongest when the communication device is of a preferred communication device (e.g., the LTE transceiver module may provide better signal quality when compared to the Wi-Fi transceiver module, the Wi-Fi 6 transceiver module may provide better signal quality when compared to the Wi-Fi 5 transceiver module). The user may then insert (or may be prompted to insert) the preferred communication device into one of the first, second and third interfaces 406A, 406B, 406C.

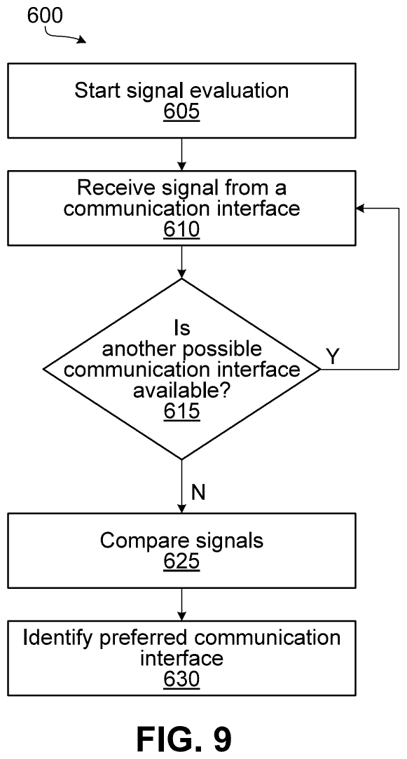

FIG. 7 illustrates a further implementation of a bathing unit system 450 including more than one communication interface 106. The bathing unit system 450 may be similar to, correspond to, or be one implementation of, the bathing unit system 10 shown in FIGS. 1 and 2. The bathing unit system 450 comprises the spa body 201 including the water receptacle 18, whereby the spa body 201 includes structural components including the sidewalls 210A, 210B, 210C and 210D and the corners 212A, 212B, 212C and 212D (shown in FIG. 3).

The bathing unit system 450 includes a connectivity unit 452. The connectivity unit 452 may be similar to, correspond to, or be one implementation of, the connectivity unit 102 shown in FIGS. 1 and 2. The connectivity unit 452 includes a first external interface 456A and a second external interface 456B coupled to the connectivity unit 452 via respective connector cables 466A and 466B. In some embodiments, the first and second external interfaces 456A and 456B may also be coupled to each other (not shown). The first and second external interfaces 456A and 456B may be positioned at respective first and second locations 458A and 458B on the spa body 201. The connectivity unit 452 may not include any internal interfaces installed directly in the connectivity unit 452 (e.g., within a housing of the connectivity unit 452). The connectivity unit 452 may be positioned at a third location on the spa body 201 separate from the first and second locations 458A and 458B.

The first and second locations 458A and 458B may be distinct from and spaced apart from each other. For example, the first and second locations 458A and 458B may be located at, or proximate, different structural components of the spa body 201. In the embodiment shown in FIG. 7, the first location 458A is at or proximate the corner 212D while the second location 458B is at or proximate the corner 212B. As such, the first and second locations 458A and 458B are positioned on opposing structural components (e.g., opposite sides) of the bathing unit system 200. However, one of ordinary skill in the art will recognize that the first and second locations 458A and 458B may be on alternative structural components of the spa body 201. In other embodiments, the first and second locations 458A and 458B may also be located at or proximate a same structural component of the spa body 201 while still being spaced apart from each other.

In some embodiments, at least one of the first and second external interfaces 456A and 456B may be fixed and immovable relative to the spa body 201 and each other in a manner similar to the second and third interfaces 406B and 406C (of the bathing unit system 400 shown in FIG. 6) described above. In other embodiments, at least one of the first and second external interfaces 456A and 456B may be movable on the spa body 201 and relative to each other in a manner similar to the first and second interfaces 206A and 206B (of the bathing unit system 200 shown in FIGS. 3 and 4A-4C) described above.

The communication device forming, or received in, at least one of the first and second external interfaces 456A and 456B may be changed from a first communication device to a second communication device. The second communication device may be another type of transceiver which allows communication over a different network (e.g., over a cellular network rather than a Wi-Fi network). Additionally or alternatively, the second communication device may also be a more powerful, longer-range, or different frequency transceiver which allows for longer-range communications over a same network or a different network (e.g., a Wi-Fi 6 transceiver module rather than a Wi-Fi 5 transceiver module). In the embodiment shown in FIG. 7, the first external interface 456A may be, may include, or may be operable to removably receive, a Wi-Fi transceiver module, a LTE transceiver module and/or a Bluetooth transceiver module; similarly, the second external interface 456B may be, may include or may be operable to receive, a Wi-Fi transceiver module, a LTE transceiver module and/or a Bluetooth transceiver module.

In some embodiments, at least one of the first and second external interfaces 456A and 456B may comprise the communication device, such that the communication device is permanently located at the first and second locations 458A and 458B. In other embodiments, the first and second external interfaces 456A and 456B may each comprise communication ports which are each configured to removably receive the communication device, such that no communication device may be permanently received in either of the first or the second external interfaces 456A or 456B.

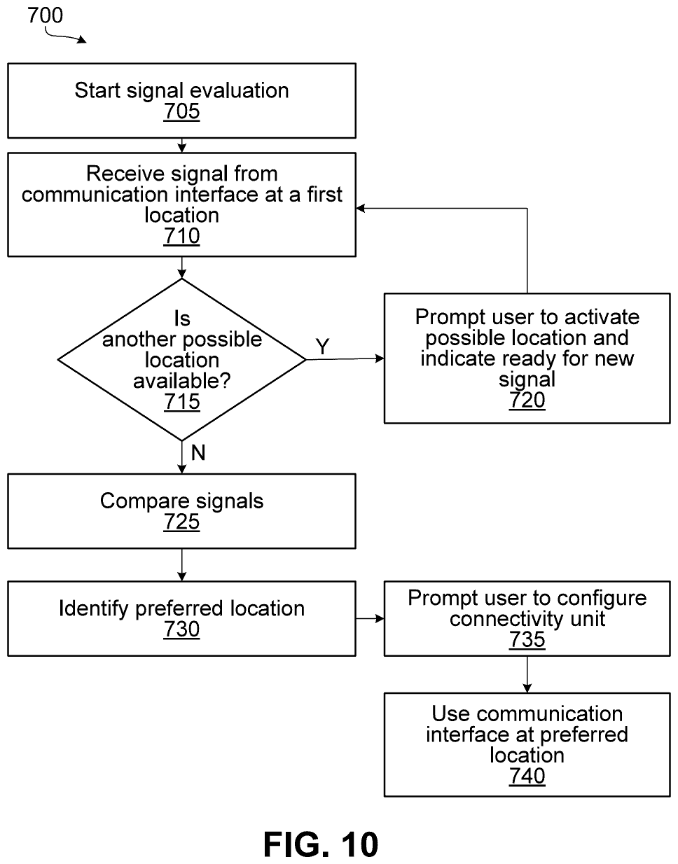

FIG. 8 illustrates a further implementation of a bathing unit system 500 including a communication interface 106. The bathing unit system 500 may be similar to, correspond to, or be one implementation of, the bathing unit system 10 shown in FIGS. 1 and 2. The bathing unit system 500 comprises the spa body 201 including the water receptacle 18, whereby the spa body 201 includes structural components including the sidewalls 210A, 210B, 210C and 210D and the corners 212A, 212B, 212C and 212D (shown in FIG. 3).

The bathing unit system 500 includes a connectivity unit 502. The connectivity unit 502 may be similar to, correspond to, or be one implementation of, the connectivity unit 102 shown in FIGS. 1 and 2. The connectivity unit 502 may not include any internal interfaces. The connectivity unit 502 may include an external interface 506A (e.g., as one of the communication interfaces 106 shown in FIG. 2) coupled to the connectivity unit 502 via a connector cable 516 and positioned at a first location 508A. The first location 508A may be at or proximate the corner 212B.

In some embodiments, at least one of the connectivity unit 502 and the external interface 506A may be fixed and immovable relative to the spa body 201 and each other in a manner similar to the second and third interfaces 406B and 406C (of the bathing unit system 400 shown in FIG. 6) described above. For example, the connectivity unit 502 may be fixed at or proximate the corner 212D. In other embodiments, at least one of the connectivity unit 502 and the first external interface 506A may be movable on the spa body 201 and relative to each other. For example, the external interface 506A may be movable to different structural components of the spa body 201 in a manner similar to the first and second interfaces 206A and 206B (of the bathing unit system 200 shown in FIGS. 3 and 4A-4C) described above.

In some embodiments, the communication device forming, or received in, the external interface 506A may be changed from a first communication device to a second communication device. The second communication device may be another type of transceiver which allows communication over a different network or the second communication device may also be a more powerful, longer-range, or different frequency transceiver which allows for longer-range communications over a same network or a different network. In the embodiment shown in FIG. 8, the external interface 506A may be, or may be operable to removably receive, a Wi-Fi transceiver module, a LTE transceiver module and/or a Bluetooth transceiver module.

In some embodiments, the external interface 506A may comprise the communication device, such that the communication device is permanently located at the first location 508A. In other embodiments, the external interface 506A may comprise a communication port which is configured to removably receive the communication device, such that no communication device may be permanently received in the external interface 506A.

### Signal Evaluation Process 600

The signal evaluation process 600 may be stored in the memory unit 42 and may include codes directing the control system 24 (e.g., the processing unit 40) to choose between two or more possible communication interfaces 106 that form a part of the various connectivity units described herein to provide a communication link between the bathing unit system 10 and the external communication network 150. As described in greater detail below, the two or more possible communication interfaces 106 may be any combination of (a) different communication interfaces 106 of a particular connectivity unit (i.e., a first communication interface and a second communication interface), (b) a same communication interface 106 but positioned at or proximate a different location on the spa body 21 or (c) a same communication interface 106 but being, including or receiving, another communication device (e.g., a second communication devices that replaces a first communication device). The signal evaluation process 600 may be a “learning mode” where a processor (e.g., the processing unit 40 of the control system 24 of FIG. 1) tests each of the possible communication interfaces 106 present and configurable to be present (of any implementation, as illustrated in FIGS. 3-8) to identify and select a preferred communication interface 106 (e.g., associated with a preferred communication device or associated with a preferred location) which has a higher level of signal strength relative to the other possible communication interface(s) 106.

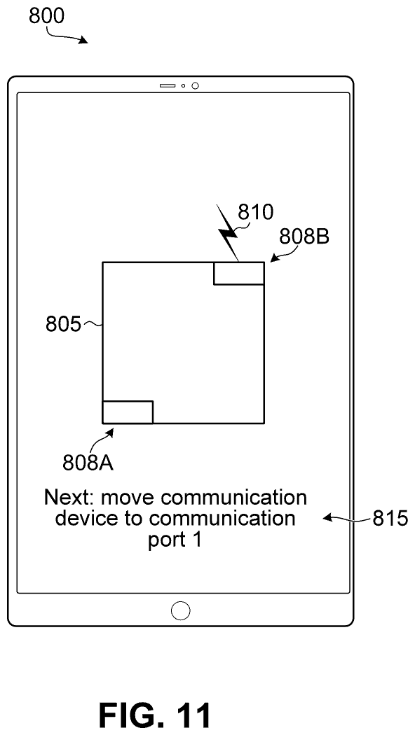

One embodiment of the signal evaluation process 600 is shown in FIG. 9. In some embodiments, the signal evaluation process 600 is performed by the processing unit 40 executing processor-readable instructions and/or computer-readable instructions stored in the memory unit 42. In other embodiments, the signal evaluation process 600 may comprise instructions stored on other types of non-transitory computer-readable storage medium. In yet other embodiments, the signal evaluation process 600 and/or parts thereof may be executed by a system other than the processing unit 40, such as the processing unit 96 of the external device 90 (shown in FIG. 2) or a processing unit of the control panel 31 (not shown). Further, although the signal evaluation process 600 in accordance with one embodiment is described with reference to the flowchart illustrated in FIG. 9, other methods of implementing the signal evaluation process 600 may alternatively be used. For example, the order of execution of the blocks shown in FIG. 9 may be altered, and/or some of the blocks described may be altered, eliminated, or combined.

The signal evaluation process 600 may begin at step 605. Step 605 may be initiated by the processing unit 40 in response to receiving a user command to initiate the signal evaluation process 600 (e.g., from the user via the control panel 31 or the external device 90). Step 605 may also be initiated by the processing unit 40 at a set time or date (e.g., upon startup of the bathing unit system 10 at the field location, or on December 31, July 1, etc.). Step 605 may also be initiated by the processing unit 40 and repeated after a set period of time, which may be regular intervals (e.g., three months after the last initiation of the signal evaluation process 600, once an hour, once a day, once a week, once a month) or irregular intervals (e.g., when the bathing unit system 10, using various sensors and methods, detects use by a bather of the bathing unit system 10).

The signal evaluation process 600 then continues to step 610, which may include computer-executable instructions directing the processing unit 40 to receive a signal originating from a first communication interface 106 that form a part of the various connectivity units described above. For example, the processing unit 40 may receive a signal from, as non-limiting examples, one of the interfaces 206A and 206B shown in FIGS. 3 and 4A-4C; one of the interfaces 306A, 306B and 306C shown in FIG. 5; one of the interfaces 406A, 406B and 406C shown in FIG. 6; one of the interfaces 456A and 456B shown in FIG. 7; and the interface 506A shown in FIG. 8. As described above, the first communication interface 106 may be, include, or be configured to removably receive a particular communication device and/or may be located at or proximate a particular location on the spa body 201. The signal used can be a test signal specifically used for testing the quality of the signals, or can be signals used in the normal operations of the associated bathing unit system.

The signal evaluation process 600 then continues to step 615, which may include computer-executable instructions directing the processing unit 40 to determine if at least one other possible communication interface 106 is available (e.g., present or is it is configurable to be present). For example, the processing unit 40 may determine if there is at least one second communication interface 106 which forms a part of the associated connectivity unit. As a more specific example, the processing unit 40 may determine if another one of the interfaces 206A and 206B shown in FIGS. 3 and 4A-4C is available; if another one of the interfaces 306A, 306B and 306C shown in FIG. 5 is available; if another one of the interfaces 406A, 406B and 406C shown in FIG. 6 is available; and if one of the interfaces 456A and 456B shown in FIG. 7 is available. As another example, the processing unit 40 may determine if it is possible to move the first communication interface 106 from a current location to another location on the spa body 201 to produce the other possible communication interface 106. The other location may be distinct from and spaced apart from the current location, and may be located on a different structural component of the spa body 201. As a further example, the processing unit 40 may determine if it is possible to replace a communication device associated with the first communication interface 106 with another communication device to produce the other possible communication interface 106. The other communication device may be another type of communication device or a same type of communication device but with a more powerful, longer-range, or different frequency transceiver. In other words, the other possible communication interface 106 may be any of (a) a different interface (i.e., a second communication interface 106) from the first communication interface 106, (b) the same interface as the first communication interface 106, but re-positioned at or proximate another location on the spa body 21 or (c) the same interface as the first communication interface 106 but being, including or receiving another communication device.

If at step 615, the processing unit 40 determines that the other possible communication interface 106 is available, the signal evaluation process 600 returns to step 610 to receive a signal originating from the other possible communication interface 106. This signal used can also be a test signal specifically used for testing the quality of the signals, or can be signals used in the normal operations of the bathing unit system. The signal evaluation process 600 then continues from step 610 as described above but using the signal received from the other possible communication interface 106.

However, if at step 615, the processing unit 40 determines that no other possible communication interface 106 are available, the signal evaluation process 600 continues to step 625, which includes computer-executable instructions directing the processing unit 40 to compare the (two or more) received signals. For example, the processing unit 40 may compare signal quality measurements of the signal received from the first communication interface 106 and the other possible communication interface(s) 106 in terms of various signal strength and reliability indicators, including without limitation, strength of the signals, signal-to-noise ratios, signal interference (e.g., amount of interference from other Wi-Fi networks operating on the same or overlapping channels, amount of interference from other networks, etc.). The processing unit 40 may determine which of the received signals has a signal quality measurement which exceeds a threshold quality level. The processing unit 40 may also determine which of the received signals has a higher or better signal quality measurement (e.g., which one has a signal quality measurement which exceeds a signal quality measurement quality of the others).

The signal evaluation process 600 then continues to step 630, which includes computer-executable instructions directing the processing unit 40 to identify a preferred communication interface 106 to establish the communication link with the external device 90 over the external communication network 150 based on the preferred communication interface 106 generating a signal which has (a) the signal quality measurement which exceeds the threshold quality level or (b) the signal quality measurement which exceeds the signal quality measurement quality of the other received signals. In situations where more than one of the received signals have a signal quality measurement which exceeds the threshold quality level, the processing unit 40 may select the preferred communication interface 106 based on cost (e.g., communicating over a Wi-Fi network may be less expensive in communicating over a cellular network), power use (e.g., communicating over a Bluetooth LE network may require less power than communicating over a Bluetooth network), relative signal quality measurements (e.g., default to the communication interface 106 having the highest or the best signal quality measurements), a user preference, etc.

The processing unit 40 may then proceed with using the preferred communication interface 106 to establish the communication link between the control system 24 and the external communication network 150 for exchanging information between the bathing unit system 10 and the one or more external devices 90. The signal evaluation process 600 may then end.

The signal evaluation process 600 described with respect to FIG. 9 may be an automated method, where the processing unit 40 dynamically and automatically selects between the two or more possible communication interfaces 106 to operate using the possible communication interface 106 with the strongest signal. As described above, such an automated method can be carried out at installation of a bathing unit system at the field location, may be carried out at set times or periodically.

### Location Evaluation Process 700

The location evaluation process 700 may be an automated process carried out by the processing unit 40 or a semi-automated process is carried out by the processing unit 40 with the help of manual interaction with the user to reposition a communication device to different possible locations on the spa body 201 (of any implementation, as illustrated in FIGS. 3-8). More specifically, the location evaluation process 700 may be stored in the memory unit 42 and may include codes directing the control system 24 (e.g., the processing unit 40) to prompt the user to (a) move a communication device between different communication interfaces 106 located at or proximate different locations on the spa body 201 or (b) move at least one communication interface 106 itself (including, being or receiving the communication device) between different locations on the spa body 201.

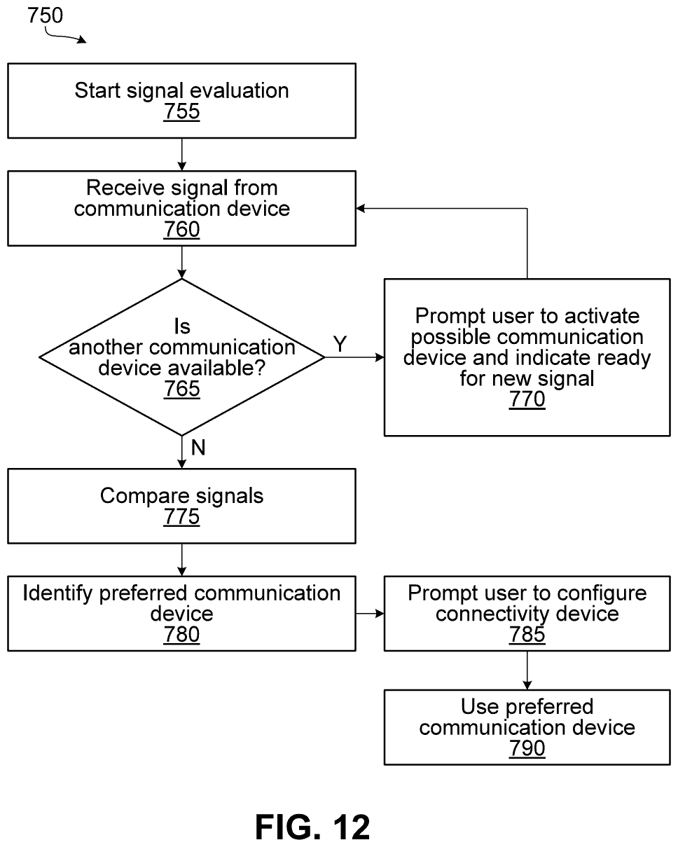

One embodiment of the location evaluation process 700 is shown in FIG. 10. In some embodiments, the location evaluation process 700 is performed by the processing unit 40 executing processor-readable instructions and/or computer-readable instructions stored in the memory unit 42. In other embodiments, the location evaluation process 700 may comprise instructions stored on other types of non-transitory computer-readable storage medium. In yet other embodiments, the location evaluation process 700 and/or parts thereof may be executed by a system other than the processing unit 40, such as the processing unit 96 of the external device 90 (shown in FIG. 2) or the processing unit of the control panel 31 (not shown). Further, although the location evaluation process 700 in accordance with one embodiment is described with reference to the flowchart illustrated in FIG. 10, other methods of implementing the location evaluation process 700 may alternatively be used. For example, the order of execution of the blocks shown in FIG. 10 may be altered, and/or some of the blocks described may be altered, eliminated, or combined.

Referring to FIG. 10, the location evaluation process 700 may begin at step 705. Step 705 may be initiated by the processing unit 40 in response to receiving a user command to initiate the location evaluation process 700 (e.g., from the user via the control panel 31 or the at least one external device 90). Step 705 may also be initiated by the processing unit 40 at a set time or date similar to the signal evaluation process 600 (shown in FIG. 9) described above. Step 705 may also be initiated by the processing unit 40 and repeated after a set period of time, which may be regular intervals or irregular intervals similar to the signal evaluation process 600 described above.

The location evaluation process 700 the continues to step 710, which may include computer-executable instructions directing the processing unit 40 to receive a signal originating from a first communication interface 106 located at a first location. For example, the processing unit 40 may receive a signal originating from, as non-limiting examples, one of the interfaces 206A and 206B at the first and second locations 208A and 208B shown in FIGS. 3 and 4A-4C; one of the interfaces 306A, 306B and 306C at the first, second and third locations 308A, 308B and 308C shown in FIG. 5; one of the interfaces 406A, 406B and 406C at the first, second and third locations 408A, 408B and 408C shown in FIG. 6; one of the interfaces 456A and 456B at the first and second locations 458A and 458B shown in FIG. 7; and the interface 506A at the first location 508A shown in FIG. 8. As described above, the first communication interface 106 may be, may include, or may be configured to receive a particular communication device.

The location evaluation process 700 then continues to step 715, which may include computer-executable instructions directing the processor 40 to determine if at least one other possible location is available. For example, the processing unit 40 may determine if there is at least one second communication interface 106 located at a second location different from the first location. In this regard, the processing unit 40 may determine if another one of the interfaces 206A and 206B at the first and second locations 208A and 208B shown in FIGS. 3 and 4A-4C is available; if another one of the interfaces 306A, 306B and 306C at the first, second and third locations 308A, 308B and 308C shown in FIG. 5 is available; if another one of the interfaces 406A, 406B and 406C at the first, second and third locations 408A, 408B and 408C shown in FIG. 6 is available; and another one of the interfaces 456A and 456B at the first and second locations 458A and 458B shown in FIG. 7 is available. In some embodiments, both the first communication interface 106 and the second communication interface 106 may be persistently or permanently associated with a communication device, and the processing unit 40 may automatically (or prompt the user to) de-activate the communication device of the first communication interface 106 at the first location and activate the communication device of the second communication interface 106 at the other second possible location. In other embodiments, the processing unit 40 may determine if it is possible to move a communication device removably received in a first communication port forming the first communication interface 106 at the first location to a second communication port forming the second communication interface 106 at the other second possible location. As another example, the processing unit 40 may determine if it is possible to move the entire first communication interface 106 from the first location to the other second possible location. In other words, the other possible location may be (a) a different interface (i.e., a second communication interface) from the first communication interface 106 located at another location on the spa body 201 or (b) the same interface as the first communication interface 106, but re-positioned at or proximate another location on the spa body 201.

If at step 715, the processing unit 40 determines that the other possible location is available, the location evaluation process 700 then continues to step 720, which may include computer-executable instructions which direct the processing unit 40 to generate a notification message prompting the user to activate the communication interface 106 at the other possible location. For example, the processing unit 40 may generate a graphical user interface (GUI) e.g., on a display screen of the control panel 31 or on a display screen of a device associated with the user prompting the user to activate the interface at the other possible location. In other embodiments, the processing unit 40 may generate and transmit a text-based notification message which may be displayed on the display screen of the control panel or the device associated with the user.

Referring to FIG. 11, one example of the user interface prompting the user to activate the communication interface 106 at the other possible location is shown generally at 800. In the embodiment shown, the user interface 800 is displayed on a display screen of a mobile device associated with the user. The mobile device may be one of the one or more external devices 90 (shown in FIG. 2). However, one of ordinary skill in the art will recognize that the user interface 800 may be implemented on the display screen of the control panel 31 or the display screen of another device associated with the user.

In the embodiment shown, the user interface 800 includes a graphical representation or icon 805 that represents a physical structure of the bathing unit system 10. The icon 805 can display the possible locations available for the communication interfaces 106, including a first location icon 808A and a second location icon 808B. The first and second location icons 808A and 808B may indicate the first and second locations of the first and second communication interfaces 106 which are fixed in place (e.g., the first, second and third locations 408A, 408B and 408C of the first, second and third interfaces 406A, 406B and 406C of bathing unit system 400 shown in FIG. 6) and into which a communication device can be inserted. The first and second location icons 808A and 808B may alternatively indicate the different locations that the first communication interface 106 can be moved to (e.g., the different second locations 208B of the second external interface 206B of bathing unit system 200 shown in FIGS. 4A-4C).

An activate icon 810 can indicate which possible location the user should activate. Notification message text 815 may indicate how the user should activate the communication interface 106 at the other possible location. For example, in embodiments where the first and second communication interfaces 106 at the first location and the possible location are permanently or persistently associated with a respective communication device, the user interface 800 (e.g., combination of the icon 805 and the text 815) may prompt the user to turn-off the first communication interface 106 at the first location and turn-on the second communication interface 106 at the possible location. However, in other embodiments where the first and second communication interfaces 106 at the first location and the possible location are communication ports configured to removably receive a communication device, the user interface 800 may instead prompt the user to move a communication device removably received in the first communication port at the first location to a second communication port at the possible location. As another example, in embodiments where the first communication interface 106 is movable from the first location to the possible location, the user interface 800 may instead prompt the user to move the entire first communication interface 106 (including, being or otherwise receiving the communication device) from the first location to the possible location.

The user interface 800 may also allow the user to generally indicate readiness for the second signal evaluation after the user has deactivated the communication interface 106 at the first location and activated the communication interface 106 at the other possible location (e.g., by turning on and off communication interfaces 106, by moving a communication device between communication ports, and/or by moving the entire communication interface 106 as applicable). After the user has indicated readiness for the second signal evaluation, the location evaluation process 700 returns to step 710 and continues therefrom as described above but using the signal received from the communication interface 106 at the other possible location.

However, if at step 715, the processing unit 40 determines that there are no further signal evaluation tests, the location evaluation process 700 continues to step 725, which may include computer-executable instructions directing the processing unit 40 to compare the (two or more) received signals. Step 725 may be similar to step 625 of the signal evaluation process 600. For example, the processing unit 40 may compare signal quality measurements of the signal received from the communication interface 106 at the first location versus the communication interface 106 at the possible location in terms of various signal strength and reliability indicators, including without limitation, strength of the signals, signal-to-noise ratios, signal interference, etc. The processing unit 40 may determine which of the received signals has a signal quality measurement which exceeds a threshold quality level. The processing unit 40 may also determine which of the received signals has a higher or better signal quality measurement (e.g., which one has a signal quality measurement that exceeds the signal quality measurement quality of the others).

The location evaluation process 700 then continues to step 730, which includes computer-executable instructions directing the processing unit 40 to select a preferred location over the external communication network 150 based on the communication interface 106 at the preferred location generating the signal (a) having the signal quality measurement which exceeds the threshold quality level or (b) having the signal quality measurement which exceeds the signal quality measurement quality of the other received signals. In situations where more than one received signal has a signal quality measurement which exceeds the threshold quality level, the processing unit 40 may select the preferred location based on relative signal quality measurements (e.g., default to the location having the highest or the best signal quality measurements) and/or a user preference. Optionally, the processing unit 40 may determine that the none of the locations tested produced signals of sufficient quality. In such a case, the processing unit 40 may generate a user interface or a notification message indicate to the user that additional test signals (e.g., at different locations, and/or with different communication device types) are advised. One or more of the signal evaluation process 600, the location evaluation process 700 and the communication device evaluation process 750 may then be initiated or re-initiated.

The location evaluation process 700 may then continue to step 735, which may include computer-executable instructions directing the processing unit 40 to configure (or to prompt the user to configure) the connectivity unit based on the preferred location identified at step 730. For example, the processing unit 40 may automatically activate the communication interface 106 at the preferred location and automatically deactivate all other communication interfaces 106 at other locations. As another example, the processing unit 40 may generate a user interface or a text-based notification message prompting the user to activate the communication interface 106 at the preferred location.

For example, referring to FIG. 11, the user interface 800 may be adapted to prompt the user to configure the connectivity unit based on the preferred location. For example, the activate icon 810 may be used to indicate the preferred location, while the notification message text 815 may be used indicate how the user should configurate the connectivity unit based on the preferred location. For example, in embodiments where the communication interface 106 at the preferred location is permanently or persistently associated with a communication device, the user interface 800 (e.g., combination of the icon 805 and the text 815) may prompt the user to turn-on the communication interface 106 at the preferred location and to turn-off the communication interfaces 106 at all other locations. However, in embodiments where the communication interfaces 106 at the preferred location is a communication port configured to removably receive a communication device, the user interface 800 may instead prompt the user to move a communication device to the communication port at the preferred location. As another example, in embodiments where the communication interface 106 is movable to the preferred location, the user interface 800 may instead prompt the user to move the entire communication interface 106 (including, being or otherwise receiving the communication device) to the preferred location.

The processing unit 40 may then continue to step 740 to proceed with using the communication interface 106 at the preferred location to establish the communication link between the control system 24 and the external communication network 150 for exchanging information between the bathing unit system 10 and the one or more external devices 90. The location evaluation process 700 may then end.

### Communication Device Evaluation Process 750

The communication device evaluation process 750 may be an automated process carried out by the processing unit 40 or a semi-automated process carried out by the processing unit 40 with the help of manual interaction with the user to switch out a first communication device into a second communication device (e.g., to a different type of communication device and/or or a same type of communication device but with a more powerful, longer-range, or different frequency transceiver). More specifically, the communication device evaluation process 750 may include codes directing the control system 24 (e.g., the processing unit 40) to prompt the user to change the first communication device forming, or received in, a communication interface 106 for the second communication device.

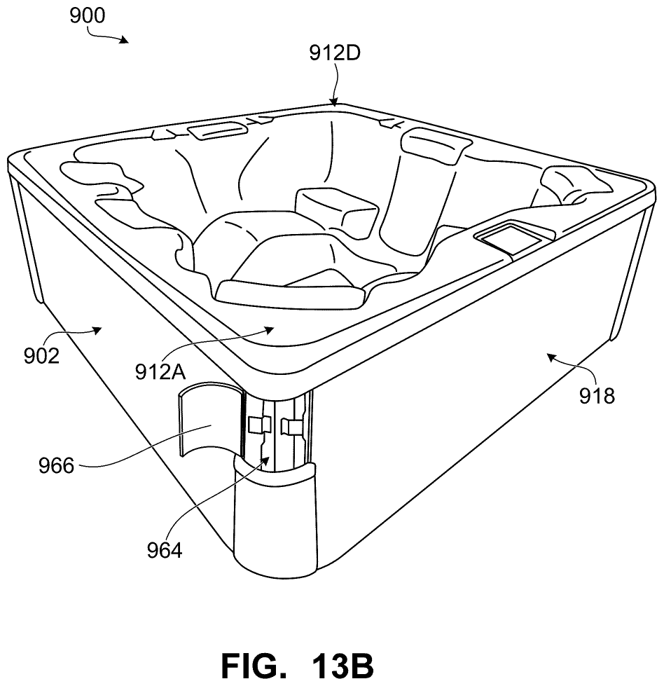

One embodiment of the communication device evaluation process 750 is shown in FIG. 12. In some embodiments, the communication device evaluation process 750 is performed by the processing unit 40 executing processor-readable instructions and/or computer-readable instructions stored in the memory unit 42. In other embodiments, the communication device evaluation process 750 may comprise instructions stored on other types of non-transitory computer-readable storage medium. In yet other embodiments, the communication device evaluation process 750 and/or parts thereof may be executed by a system other than the processing unit 40, such as the processing unit 96 of the external device 90 (shown in FIG. 2) or the processing unit of the control panel 31 (not shown). Further, although the communication device evaluation process 750 in accordance with one embodiment is described with reference to the flowchart illustrated in FIG. 12, other methods of implementing the communication device evaluation process 750 may alternatively be used. For example, the order of execution of the blocks shown in FIG. 12 may be altered, and/or some of the blocks described may be altered, eliminated, or combined.

Referring to FIG. 12, the communication device evaluation process 750 may begin at step 755. Step 755 may be initiated by the processing unit 40 in response to receiving a user command to initiate the communication device evaluation process 750 (e.g., from the user via the control panel 31 or the at least one external device 90). Step 755 may also be initiated by the processing unit 40 at a set time or date similar to the signal evaluation process 600 (shown in FIG. 9). Step 755 may also be initiated by the processing unit 40 and repeated after a set period of time, which may be regular intervals or irregular intervals similar to the signal evaluation process 600 described above.

The communication device evaluation process 750 the continues to step 760, which may include computer-executable instructions directing the processing unit 40 to receive a signal originating from a first communication interface 106 being, including, or receiving a first communication device. For example, the processing unit 40 may receive a signal originating from, as non-limiting examples, one of the interfaces 206A and 206B shown in FIGS. 3 and 4A-4C; one of the interfaces 306A, 306B and 306C shown in FIG. 5; one of the interfaces 406A, 406B and 406C shown in FIG. 6; one of the interfaces 456A and 456B shown in FIG. 7; and the interface 506A shown in FIG. 8.

The communication device evaluation process 750 then continues to step 765, which may include computer-executable instructions directing the processor 40 to determine if at least one other possible communication device is available. For example, the processing unit 40 may determine if the first communication interface 106 can be modified to be, to include or to receive the other possible communication device. In this regard, the processing unit 40 may determine if the one of the interfaces 206A and 206B shown in FIGS. 3 and 4A-4C can include, be, or receive the other possible communication device; if the one of the interfaces 306A, 306B and 306C shown in FIG. 5 can include, be, or receive the other possible communication device; if the one of the interfaces 406A, 406B and 406C at the shown in FIG. 6 can include, be, or receive the other possible communication device; if the one of the interfaces 456A and 456B shown in FIG. 7 can include, be, or receive the other possible communication device, or if the interface 506A shown in FIG. 8 can include, be, or receive the other possible communication device. In some embodiments, the first communication interface 106 may be persistently or permanently associated with both the first communication device and the second possible communication device, and the processing unit 40 may automatically (or prompt the user to) de-activate the first communication device and to activate the second possible communication device. For example, the first communication interface 106 may include both a Wi-Fi transceiver as the first communication device and a cellular transceiver as the second communication device; the processing unit 40 may automatically activate the cellular transceiver and deactivate the Wi-Fi transceiver, or vice versa. In other embodiments, the first communication interface 106 may be a communication port configured to removably receive the first communication device, and the processing unit 40 may determine if it is possible for the first communication interface 106 to removably receive the second possible communication device.

In some embodiments, step 765 may also include computer-executable instructions directing the processor 40 to determine which type of communication device should be used. For example, if the first communication interface 106 with the first communication device receives little to no signal, the processor 40 may determine that a different type of communication device should be used as the second communication device (e.g., switch the Wi-Fi transceiver into a cellular transceiver or a RF transceiver). However, if the first communication interface 106 with the first communication device receives weak or medium signal, the processor 40 may instead determine that a same type of communication device that is capable of longer-range or a different frequency should be used as the second communication device instead (e.g., switch the standard Wi-Fi transceiver into a longer-range Wi-Fi transceiver).

If at step 765, the processing unit 40 determines that the other possible communication device is available, the communication device evaluation process 750 then continues to step 770, which may include computer-executable instructions which direct the processing unit 40 to generate a notification message prompting the user to activate the other possible communication device at the first communication interface 106. For example, the processing unit 40 may generate a graphical user interface (GUI) e.g., on the display screen of the control panel 31 or on the display screen of the device associated with the user, prompting the user to activate the second possible communication device. In other embodiments, the processing unit 40 may generate and transmit a text-based notification message which may be displayed on the display screen of the control panel or the device associated with the user.

For example, referring to FIG. 11, the user interface 800 may be adapted to prompt the user to activate the second possible communication device at the first communication interface 106. In particular, the activate icon 810 may be used to indicate the location of the first communication interface 106, while the notification message text 815 may indicate how the user should activate the second possible communication device at the first communication interface 106. For example, in embodiments where the communication interface 106 is permanently or persistently associated with both the first communication device and the second possible communication device, the user interface 800 (e.g., combination of the icon 805 and the text 815) may prompt the user to turn-on the possible communication device and to turn-off the first communication device at the first communication interface 106. In other embodiments where the first communication interfaces 106 is a communication port configured to removably receive the first communication device and second possible communication device, the user interface 800 may instead prompt the user to remove the first communication device and to insert the second possible communication device.

The user interface 800 may also allow the user to generally indicate readiness for the second signal evaluation after the user has deactivated the first communication device and activated the second possible communication device at the first communication interface 106 (e.g., by turning on and off the communication devices and/or by switching the communication device as applicable). After the user has indicated readiness for the second signal evaluation, the communication device evaluation process 750 returns to step 760 and continues therefrom as described above but using the signal received from the second possible communication device at the first communication interface 106.

However, if at step 765, the processing unit 40 determines that there are no further signal evaluation tests, the communication device evaluation process 750 continues to step 775, which may include computer-executable instructions directing the processing unit 40 to compare the (two or more) received signals. Step 775 may be similar to step 625 of the signal evaluation process 600. For example, the processing unit 40 may compare signal quality measurements of the signal received from the first communication device at the communication interface 106 versus the second possible communication device at the communication interface 106 in terms of various signal strength and reliability indicators, including without limitation, strength of the signals, signal-to-noise ratios, signal interference, etc. The processing unit 40 may determine which of the received signals has a signal quality measurement which exceeds a threshold quality level. The processing unit 40 may also determine which of the received signals has a higher or better signal quality measurement (e.g., which one has a signal quality measurement that exceeds the signal quality measurement quality of the others). Optionally, the processing unit 40 may also determine that the none of the communication devices tested produced signals of sufficient quality. In such a case, the processing unit 40 may generate a user interface or a notification message to indicate to the user that additional test signals (e.g., at different locations, and/or with different communication device types) are advised. One or more of the signal evaluation process 600, the location evaluation process 700 and the communication device evaluation process 750 may then be initiated or re-initiated.

The communication device evaluation process 750 then continues to step 780, which includes computer-executable instructions directing the processing unit 40 to select a preferred communication device to establish the communication link with the external device 90 over the external communication network 150 based on the communication interface 106 with the preferred communication device generating the received signal (a) having the signal quality measurement which exceeds the threshold quality level or (b) having the signal quality measurement which exceeds the signal quality measurement quality of the other received signals. In situations where more than one received signal has a signal quality measurement which exceeds the threshold quality level, the processing unit 40 may select the preferred location based on costs, power use, relative signal quality measurements (e.g., default to the communication device having the highest or the best signal quality measurements), a user preference, etc.

The communication device evaluation process 750 may then continue to step 785, which may include computer-executable instructions directing the processing unit 40 to configure (or to prompt the user to configure) the connectivity unit based on the preferred communication device identified at step 780. For example, the processing unit 40 may automatically activate the preferred communication device at the communication interface 106. As another example, the processing unit 40 may generate a user interface or a text-based notification message prompting the user to activate the preferred communication device at the communication interface 106.

For example, referring to FIG. 11, the user interface 800 may be adapted to prompt the user to configure the connectivity unit based on the identified preferred communication device. In particular, the activate icon 810 may be used to indicate the location of the communication interface 106, while the notification message text 815 may be used indicate how the user should configurate the connectivity unit based on the preferred communication device. For example, in embodiments where the communication interface 106 is permanently or persistently associated with the preferred communication device, the user interface 800 (e.g., combination of the icon 805 and the text 815) may prompt the user to turn-on the preferred communication device and to turn-off all other communication devices. In other embodiments where the communication interfaces 106 is a communication port configured to removably receive the preferred communication device, the user interface 800 may instead prompt the user to remove any other communication device received in the communication port and to insert the preferred communication device.

The processing unit 40 may then proceed with step 790 to use the preferred communication device at the communication interface 106 to establish the communication link between the control system 24 and the external communication network 150 for exchanging information between the bathing unit system 10 and the one or more external devices 90. The communication device evaluation process 750 may then end.

### Bathing Unit System 900

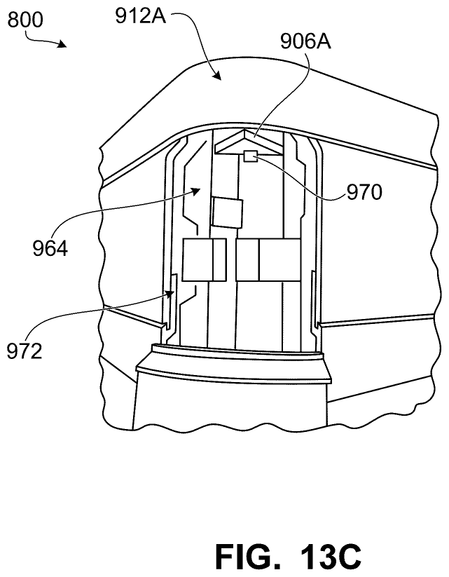

FIGS. 13A-B show a bathing unit system 900 with more than one possible communication interface 106, and in particular, two communication ports 906A and 906B at two different locations. The bathing unit system 900 may be similar to, correspond to, or be one implementation of, the bathing unit system 10 shown in FIGS. 1 and 2. The bathing unit system 900 includes a spa body 901 including a water receptacle 18, whereby the spa body 201 includes structural components including sidewalls and corners, including diagonally opposed corners 912A and 912B. In the configuration shown, the diagonally opposed corners 912A and 912D are the locations for, respectively, the communication ports 906A and 906B. In other embodiments, the communication ports 906A and 906B can be located at any of the corners of the spa body 901 or at or proximate any other structural component of the spa body 901.

The communication ports 906A and 906B are similar to the second and third interfaces 406B and 406C (of the bathing unit system 400 shown in FIG. 6) and the first and second external interfaces 452A and 456B (shown in FIG. 7) discussed above. In this regard, the communication ports 906A and 906B may be fixed and immovable relative to the spa body 901 and each other. The communication ports 906A and 906B may also generally be configured to removably receive a communication device, and in particular, to removably receive a variety of different communication devices (e.g., different types of transceivers which allow communication over different networks or a more powerful, longer-range, or different frequency transceiver which allows for longer-range communications over a same network or a different network).

The communication ports 906A and 906B are each protected by a respective cover 966 that is releasably attached to a spa shell forming the spa body 901. The cover 966 can span a portion of a height of the spa body 901. For example, the cover 966 can span up to about 20% of the height of the spa body 901, or up to about 50% of the height, or up to 100% of the height. The cover 966 can be shaped to mimic the shape and curvature of the corners of the spa body 901 (e.g., the corners that do not include communication ports, or the portion of the corners 912A and 912D not spanned by the cover 966). The cover 966 can have other shapes as well based on the location of the corresponding communication port 906A and 906B on the spa body 201, such as being non-curved if the corresponding communication port 906A and 906B is located at a structural component on the spa body 201 other than the corners, can be circular, rectangular, etc.

In FIG. 13A, the cover 966 is shown covering a cavity 964 beneath the cover 966. In FIG. 13B, the cover 966 has been opened to expose the cavity 964 beneath. Referring as well to FIG. 13C, which shows a closer view of the communication port 906A, the user can remove the cover 966 to access the cavity 964 beneath that includes the communication port 906A that is configured to accept one or more types of communication devices 970. The user can install or replace the communication device 970 at the communication port 906A (or any applicable communication interface 106 discussed above). The cover 966 can also enclose the connectivity unit 102 in its housing 104 as described above. The cover 966 may be made of a material which is generally permeable to wireless signals, such as Bluetooth signals, Wi-Fi signals and cellular signals. Positioning the communication ports 906A and 906B at the corners 912A and 912D, within the cavity 964 and/or behind a signal permeable cover 966 can allow the communication ports 906A and 906B to be positioned at the outer edges of the bathing unit system 900 and in an area which is relatively unobstructed by other structural components of the spa body 901 (e.g., cabinet insulation, the spa cover, structural panels of a spa cabinet, the water receptacle 918). This can increase the likelihood that, when the bathing unit system 900 is installed at the field location, there is at least one communication port 906A and 906B positioned close enough to the source of network signal such that a communication device received in the at least one communication port 906A and 906B is capable of receiving a sufficiently strong signal from the source of the network signals.

The cover 966 attaches to the spa shell 960 using any suitable fastener 972. The fasteners can include a hinge and latch, pieces that slot together, the cover 966 being sized to have an interference fit with the spa shell, etc. In some embodiments, the cover 966 forms a watertight seal when attached to the spa shell 960. When opened so that the user can access the cavity 964 that includes the communication port 906A, the cover 966 can be completely removable from the spa shell 960. Alternatively, the cover 966 can be displaced while remaining attached to the spa shell 960, e.g., by sliding with respect to the spa shell 960, or hinging open at a hinge point.

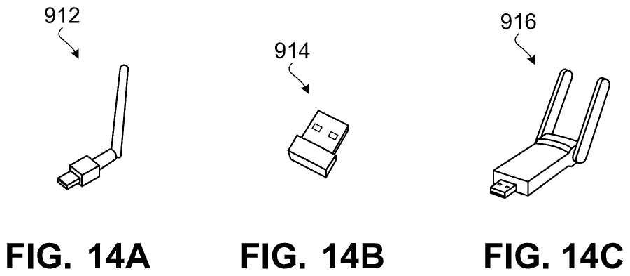

FIGS. 14A-C illustrate some of the communication types 968 that can be connected at port 906A. These can include a Wi-Fi-USB transceiver with one articulated antenna (communication device 912 in FIG. 14A), a basic Wi-Fi-USB transceiver module with one hidden antenna (communication device 914 in FIG. 14B), and a Wi-Fi-USB transceiver with two articulated antennae (communication device 916 in FIG. 14C). In this regard, all of the communication devices 912, 914 and 916 may be of a same type (e.g., all are Wi-Fi transceivers). However, the communication device 916 with the two articulated antennae may be longer range than communication device 912 with the one articulated antenna, which may be longer range than communication device 914 with the hidden antenna. Other types of communication devices are also possible, including a cellular-USB transceiver, a Bluetooth-USB transceiver, etc.

Certain additional elements that may be needed for operation of some embodiments have not been described or illustrated as they are assumed to be within the purview of those of ordinary skill in the art. Moreover, certain embodiments may be free of, may lack and/or may function without certain elements disclosed herein.

All references cited throughout the specification are hereby incorporated by reference in their entirety for all purposes.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this invention pertains. In the case of conflict, the present document, including definitions will control. As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

Although the present invention has been described in considerable detail with reference to certain embodiments thereof, variations and refinements are possible and will become apparent to the person skilled in the art in view of the present description. The invention is defined more particularly by the attached claims.

What is claimed is:

1. A bathing unit system comprising:
a spa body including a water receptacle for holding water;
a plurality of bathing unit components including at least one heater and a circulation pump, the at least one heater and the circulation pump being installed in a circulation system configured for circulating water to and from the water receptacle;
a control system configured to generate control signals for controlling operational settings of one or more of the plurality of bathing unit components including the at least one heater and the circulation pump; and
at least two communication interfaces positioned in the spa body, each of the at least two communication interfaces being for exchanging of information between the control system and an external communication network, the at least two communication interfaces including a first communication interface and a second communication interface, wherein the first communication interface is spaced apart from the second communication interface on the spa body.

2. The bathing unit system of claim 1, said bathing unit system further comprising a processor configured for:
a. processing signals originating from the first communication interface and the second communication interface to identify a preferred communication interface between the first communication interface and the second communication interface, the preferred communication interface being associated with signals having quality measurements:
i. exceeding a threshold quality level; and/or
ii. exceeding quality measurements of another communication interface amongst the first communication interface and the second communication interface; and
b. using the preferred communication interface to establish a communication link between the control system and the external communication network for the exchanging of the information.

3. The bathing unit system of claim 2, wherein the quality measurements includes at least one of a signal-to-noise ratio, a signal strength, a signal reliability measure and an amount of interference from other communication networks.

4. The bathing unit system of claim 1, wherein the first communication interface is located at a first location on the spa body and the second communication interface is located at a second location on the spa body spaced apart from the first location.

5. The bathing unit system of claim 4, wherein:
a. the second location is at an opposing side of the spa body from the first location; or
b. the second location is a first corner of the spa body, and the first location is a second corner of the spa body, the first corner being opposite to the second corner.

6. The bathing unit system of claim 4, wherein the at least two communication interfaces include a third communication interface located at a third location on the spa body, the third location being spaced apart from the first location and the second location.

7. The bathing unit system of claim 1, wherein:
a. at least one of the at least two communication interfaces includes a transceiver; or
b. each of the at least two communication interfaces includes a transceiver.

8. The bathing unit system of claim 1, wherein at least one of the at least two communication interfaces comprises a communication port configured to removably receive a transceiver.

9. The bathing unit system of claim 8, wherein the communication port is a USB port.

10. The bathing unit system of claim 7, wherein the transceiver is one of a Bluetooth transceiver, a Wi-Fi transceiver, a Wi-Fi-USB transceiver, a cellular transceiver module and a cellular-USB transceiver.

11. The bathing unit system of claim 1, wherein one of the at least two communication interfaces is positioned at an end of a connector cable.

12. The bathing unit system of claim 11, wherein the connector cable is a USB extension cable.

13. The bathing unit system of claim 1, wherein at least one of the first communication interface and the second communication interface is positioned within a cavity formed on a spa shell of the spa body.

14. The bathing unit system of claim 13, wherein the cavity is located on a corner of the spa shell.

15. The bathing unit system of claim 13, further comprising a removable cover enclosing the cavity.

16. A bathing unit system comprising:
a. a spa body including a water receptacle for holding water;
b. a plurality of bathing unit components including at least one heater and a circulation pump, the at least one heater and the circulation pump being installed in a circulation system configured for circulating water to and from the water receptacle;
c. a control system configured to generate control signals to control operational setting of one or more of the plurality of bathing unit components in the bathing unit system including the at least one heater and the circulation pump;
d. a connectivity unit located at a first location on the spa body, the connectivity unit including a first communication device for exchanging information between the control system and an external communication network; and
e. at least one communication port connected to the spa body, the at least one communication port being configured to removably receive a second communication device for exchanging information between the control system and the external communication network.

17. The bathing unit system of claim 16, wherein the first communication device is fixed relative to the spa body.

18. The bathing unit system of claim 16, wherein the at least one communication port is located at a second location on the spa body, the second location being a fixed location distinct from and spaced apart from the first location.

19. The bathing unit system of claim 16, wherein the at least one communication port is located at an end of a connector cable, wherein the at least one communication port is configured to be moved on the spa body relative to the first location.

20. The bathing unit system of claim 16, wherein a spa shell of the spa body comprises a cavity with a removable cover enclosing the cavity, the at least one communication port being located within the cavity.

21. The bathing unit system of claim 20, wherein the cavity is formed on a corner of the spa shell.

22. The bathing unit system of claim 16, said bathing unit system further comprising a processor configured for:
a. processing signals originating from the first communication device to derive a specific quality measurement:
i. in response to the specific quality measurement meeting a threshold quality level, using the first communication device to establish a communication link between the control system and the external communication network; or
ii. in response to the specific quality measurement failing to meet the threshold quality level, initiate a process for using a communication device removably received in the at least one communication port to establish the communication link between the control system and the external communication network; and
b. exchanging information between the control system and the external communication network over the established communication link.

23. The bathing unit system of claim 22, wherein the process for using a communication device removably received in the at least one communication port includes generating a notification message for a user of the bathing unit system prompting the user to connect the second communication device to the at least one communication port.

24. The bathing unit system of claim 16, said bathing unit system further comprising a processor configured for:
a. processing quality measurements corresponding to signals originating from the first communication device and from the second communication device removably received in the at least one communication port to identify a preferred communication device between the first communication device and the second communication device, the preferred communication device being associated with a quality measurement:
i. exceeding a threshold quality level; and/or
ii. exceeding quality measurements of other signals amongst the signals originating from the first communication device and the second communication device;
b. exchanging information between the control system and the external communication network using the preferred communication device.

25. The bathing unit system of claim 16, wherein at least one of the first communication device and the second communication device is one of a Bluetooth transceiver, a Bluetooth-USB transceiver, a Wi-Fi transceiver, a Wi-Fi-USB transceiver, a cellular transceiver and a cellular-USB transceiver.

26. A method of dynamically selecting a communication interface for establishing a communication link between a controller of a bathing unit system and an external communication network, the bathing unit system including a spa body including a water receptacle for holding water, the method comprising:
a. receiving, at a processor of the bathing unit system, a first signal originating from a first communication interface positioned at a first location on the spa body;
b. receiving, at the processor of the bathing unit system, a second signal originated from a second communication interface positioned at a second location on the spa body, the second location being distinct from the first location;
c. processing the first signal and the second signal to identify a preferred communication interface between the first communication interface and the second communication interface, the preferred communication interface being associated with signal quality measurements:
i. exceeding a threshold quality level; and/or
ii. exceeding quality measurements of another one of the first communication interface and the second communication interface; and
d. using the preferred communication interface to establish the communication link between the controller and the external communication network for exchanging information between the bathing unit system and one of more external devices.

27. The method of claim 26, comprising repeating steps a. to d. at a regular interval or in response to a detected use by a user of the bathing unit system.

28. The method of claim 26, wherein the first communication interface comprise a first communication device positioned at the first location, the second communication interface comprise the first communication device moved to and positioned at the second location, and the preferred communication interface comprises a preferred location between the first location and the second location.

29. A method of selecting a communication device for establishing a communication link between a controller of a bathing unit system and an external communication network, the bathing unit system including a spa body including a water receptacle for holding water and an outer shell, the method comprising:
a. receiving, at a processor of the bathing unit system, a first signal originating from a first communication device positioned at a first location on the spa body;
b. prompting a user to provide an indication of test readiness conveying that a second communication device has been positioned at the first location on the spa body;
c. receiving, at the processor of the bathing unit system, a second signal originating from the second communication device positioned at the first location;
d. processing the first signal and the second signal to identify a preferred communication device between the first communication device and the second communication device, the preferred communication device being associated with signal quality measurements:
i. exceeding a threshold quality level; and/or
ii. exceeding quality measurements of another one of the first communication device and the second communication device;
e. generating a notification message prompting the user to connect the preferred communication device at the first location; and
f. using the preferred communication device at the first location to establish the communication link between the controller and the external communication network for exchanging information between the bathing unit system and one of more external devices.

30. The method of claim 29, wherein the second communication device is a first communication device type and the first communication device is a second communication device type, wherein the first communication device type and the second communication device type are different.

31. The method of claim 30, wherein the first communication device type is a Wi-Fi transceiver module and wherein the second communication device type is a cellular transceiver module, a type F antenna, or a dipole antenna.
